(19) United States
(12) Patent Application Publication
(10) Pub. No.: US 2016/0158701 A1
(43) Pub. Date: Jun. 9, 2016

(54) CONTROLLING AQCS PARAMETERS IN A COMBUSTION PROCESS

(71) Applicant: BABCOCK & WILCOX POWER GENERATION GROUP, INC., Barberton, OH (US)

(72) Inventors: Shannon R. Brown, Doylestown, OH (US); Daniel B. Johnson, Orland Park, IL (US); Mandar R. Gadgil, Akron, OH (US); Steve Feeney, Lancaster, OH (US); Paul J. Williams, Akron, OH (US); Albert P. Moretti, Stow, OH (US); Anthony A. Silva, Wadsworth, OH (US); Timothy A. Fuller, North Canton, OH (US); Garrett E. Pavlovicz, Akron, OH (US); Stephen Ullom, Niles, OH (US); Daniel P. Schaper, Uniontown, OH (US)

(21) Appl. No.: 14/906,394

(22) PCT Filed: Jul. 25, 2014
(86) PCT No.: PCT/US14/48231

§ 371 Date: Jan. 20, 2016

Related U.S. Application Data
(63) Continuation-in-part of application No. 13/837,221, filed on Mar. 15, 2013.
(60) Provisional application No. 61/858,478, filed on Jul. 25, 2013.
(60) Provisional application No. 61/950,636, filed on Mar. 10, 2014.
(60) Provisional application No. 61/752,167, filed on Jan. 14, 2013.

(51) Int. Cl. B01D 53/94; F23J 15/02

(52) U.S. Cl. CPC B01D 53/9495; F23J 15/02; F23J 2215/20

(57) ABSTRACT

The present invention relates generally to the generation of steam via the use of a combustion process to produce heat and, in one embodiment, to a device, system and/or method that enables one to control one or more process parameters of a combustion process so as to yield at least one desirable change in at least one downstream parameter. In one embodiment, the present invention relates to measuring or determining at least one process parameter of a combustion system and using the information obtained from same to control at least one component of the combustion system.

### RELATED APPLICATION DATA

This international patent application claims priority to and is a continuation-in-part of U.S. patent application Ser. No. 13/837,221 filed Mar. 15, 2013 and titled “System and Method for Controlling One or More Process Parameters Associated with a Combustion Process,” which itself claims priority to and is a non-provisional of U.S. Provisional Patent Application No. 61/752,167 filed Jan. 14, 2013 and titled “ System and Method for Controlling One or More Process Parameters Associated with a Combustion Process.” This international application is also a continuation-in-part of and claims priority to both U.S. Provisional Patent Application No. 61/858,478 filed Jul. 25, 2013 and titled “Sorbent Injection and Electrostatic Precipitator Control System Integration,” and U.S. Provisional Patent Application No. 61/950,636 filed Mar. 10, 2014 and titled “Air Quality Control Systems, Uses for Same and Methods of Controlling Same.” The complete text of these patent applications are hereby incorporated by reference as though fully set forth herein in their entireties.

### FIELD AND BACKGROUND OF THE INVENTION

1. Field of the Invention

The present invention relates generally to the generation of steam via the use of a combustion process to produce heat and, in one embodiment, to a device, system and/or method that enables one to control one or more process parameters of a combustion process so as to yield at least one desirable change in at least one downstream parameter. In one embodiment, the present invention is directed to a system and/or method for controlling at least one process parameter of a combustion process so as to yield at least one desirable change in at least one downstream process parameter associated with one or more of a wet flue gas desulfurization (WFGD) unit, a particulate collection device and/or control of additives thereto and/or a nitrogen oxide control device and/or control of additives thereto and/or additives to the system. In another embodiment, the present invention is directed to a system and/or method for controlling at least two process parameters of a combustion process so as to yield at least one desirable change in at least one downstream process parameter associated with one or more of a wet flue gas desulfurization (WFGD) unit, a particulate collection device and/or control of additives thereto and/or a nitrogen oxide control device and/or control of additives thereto and/or additives to the system. In still another embodiment, the present invention relates to measuring or determining at least one process parameter of a combustion system and using the information obtained from same to control at least one component of the combustion system.

2. Description of the Related Art

A variety of SO₂ control processes and technologies are in use and others are in various stages of development. Commercialized processes include wet, semidry (slurry spray with drying) and completely dry processes, The wet flue gas desulfurization (WFGD) scrubber is the dominant worldwide technology for the control of SO₂ from utility power plants, with approximately 85 percent of the installed capacity, although the dry flue gas desulfurization (DFGD) systems are also used for selected lower sulfur applications.

Wet scrubbing processes are often categorized by reagent and other process parameters. The primary reagent used in wet scrubbers is limestone. However, any alkaline reagent can be used, especially where site-specific economics provide an advantage. Other common reagents are lime (CaO), magnesium enhanced lime (MgO and CaO),ammonia (NH₃), and sodium carbonate (Na₂CO₃).

A number of the wet processes are also classified as either non-regenerable or regenerable systems. In non-regenerable systems, the reagent in the scrubber is consumed to directly generate a byproduct containing the sulfur, such as gypsum. In regenerable systems, the spent reagent is regenerated in a separate step to renew the reagent material for further use and to produce a separate byproduct, such as elemental sulfur. The dominant limestone and lime reagent systems used today are nonregenerable. In many cases the regenerable systems have been retrofitted with nonregenerable limestone or lime reagent systems to reduce costs and improve unit availability.

As known to those of skill in the art, the most common WFGD absorber module is the spray tower design (see, e.g., Steam/its generation and use, 41st Edition, Kitto and Stultz, Eds., Copyright 2005, The Babcock & Wilcox Company, Barberton, Ohio, U.S.A., particularly Chapter 35 Sulfur Dioxide Control, the complete text of which is hereby incorporated by reference as though fully set forth herein). In the most common WFGD set-up the flue gas enters the side of the spray tower at approximately its midpoint and exits through a transition at the top. The upper portion of the module (absorption zone) provides for the scrubbing of the flue gas to remove the SO₂ while the lower portion of the module serves as an integral slurry reaction tank (also frequently referred to as the recirculation tank (or absorber recirculation tank) and oxidation zone) to complete the chemical reactions to produce gypsum. The self-supporting absorber towers typically range in diameter from 20 feet to 80 feet (6 meters to 24 meters) and can reach 150 feet (46 meters) in height. In some designs, the lower reaction tank is flared downward to provide a larger diameter tank for larger slurry inventory and longer retention time, Other key components include the slurry recirculation pumps, interspatial spray headers and nozzles for slurry injection, moisture separators to minimize moisture carryover, an oxidizing air injection system, slurry reaction tank agitators to prevent settling, and the perforated tray to enhance SO2 removal performance.

It has been found that higher concentrations (generally above about 700 ppm) of one or more oxidizers including, but not limited to persulfate, permanganate, manganate, ozone, hypochlorite, chlorate, nitric acid, iodine, bromine, chlorine, fluorine, or combinations of any two or more thereof, coupled with thermodynamically favorable pH and oxidation-reduction potential (ORP) (generally above 500 mV) conditions in the wet scrubber, will cause soluble manganese (Mn²⁺) to form MnO.,, precipitate, as well as impact upon the nature, the amount and/or the conditions of mercury reemission and selenium emission from the WFGD. Additionally, the ORP in a WFGD can impact emission rate and/or phase partitioning and/or the nature of one or more other compounds, or species. Additionally, the ORP in a WFGD absorber tank can influence the oxidation state of any selenium as well as other ionic species that are present in the absorber tank thereby impacting the ability to control the emission of one or more selenium species and/or one or more other ionic species commonly found in the ART of a WFGD (e.g., emission in, from and/or out of a waste water treatment unit or system, etc.). Generally speaking, ORP of greater than about 300 mV in an absorber recirculation tank (ART) tends to favor the formation of selenium (VI) species and/or compounds (e.g., selenate ions and/or compounds, etc.),

Additionally, the control of various Air Quality Control Systems (AQCS) are in need of optimization. As more and more power generation utilities are beginning to vary megawatt (MW) output, the boilers, SCRs, SNCRs, bag houses, ESPs and WFGD are being “asked” to fluctuate performance to respond to these changes in load. Thus, there is a need for various optimization programs that will permit for a more efficient use of ammonia, power input in the ESPs, limestone and/or lime injection into the WFGD or DFGDs and a potential for a higher quality gypsum byproduct, power in a WFGD, and/or the various pumps in use in connection with the WFGD unit.

Furthermore, various parameters impact one or more of Dry Sorbent Injection (DSI) systems and/or \Net Sorbent Injection (WS!) systems, Activated Carbon Injection (ACI) systems, water injection (WI) for gas conditioning and/or the operation and/or various parameters of one or more electrostatic precipitators (ESPs).

Previously, one method for controlling sorbent injection distribution/flow rate and ESP operation to mitigate the emissions of particulate, Hg, SO₃ and other contaminants contained in flue gas formed during the combustion of coal/mercury/sulfur bearing fossil fuels and waste materials, which are burned by electrical power generating plants, waste recycle plants and other industrial processes, to comply with federal and state air pollution requirements, is to control the sorbent/water injection system(s) and ESP operation separately thereby disregarding the impact the operation of each of these systems have on one another.

It is known in the industry that SO₃ in the flue gas reduces the effectiveness of Powdered Activated Carbon (PAC) absorption of Hg & VOC's because it competes for the active surface area sites on the PAC particles and also tends to plug some of the pores. The typical effect of SO₃ on the amount of PAC required is presented in FIG. 1.

On the other hand, SO₃ improves the performance of a Dry Electrostatic Precipitator (ESP) by reducing the ash resistivity. A Dry Sorbent Injection (DSO System and/or Wet Sorbent Injection (WSI) System are typically used to reduce SO₃ and enhance Hg removal in Activated Carbon Injection (ACI) systems where PAC is used. As a result, DSI and/or WSI systems have the potential to cause higher opacity levels in the gas stream exiting the ESP due to increased resistivity in some or all sections of the ESP because of the reduced SO₃ concentration. The use of hydrated lime for DSI and/or PAC could cause higher ash resistivity in the ESP resulting in poor ESP performance and higher particulate emissions.

The amount of particulate removal from the flue gas by an ESP is dependent upon the applied corona power. Corona power is the product of corona current and voltage. Current is needed to charge the particles. Voltage is needed to support an electrical field, which in turn transports the particles to the collecting plates. Increases in corona power result in increases in collecting efficiency. Reductions in ash resistivity will help to improve Corona power levels whereas increases in ash resistivity will negatively impact corona power.

In light of the above, the previously methods for control are to control each piece of equipment individually—DSI and/or WSI for acid gas control, WI (water injection) for gas conditioning, ACI for Hg control, and the ESP spark rate for optimal power input to control particulate emissions. The current individual control technologies do not address the overall impact in performance on each other.

Given the above, a need exists in the art for a system and/or method by which to control one or more process parameters of a combustion process so as to yield a favorable change in and/or permit the control of the ORP of a WFGD absorber tank thereby resulting in the ability to control one or more downstream parameters so as to positively impact the ORP in the absorber tank of a WFGD unit, improve the operation of a WFGD unit, or improve, mitigate and/or control the emission of one or more species or compounds that occur from or downstream of a WFGD unit. Additionally a need exists to control the parameters of the various AQCS equipment to allow for one or more holistic optimization programs for one or more portions, of the totality, of an AQCS. Furthermore, a need exists in the art for a device, system and/or method that permits one to control and/or optimize the performance of one or more of a DSI, ACI, WSI, WI and/or ESP by measuring, analyzing and/or controlling one or more operating parameters in real time.

### SUMMARY OF THE INVENTION

The present invention relates generally to the generation of steam via the use of a combustion process to produce heat arid, in one embodiment, to a device, system and/or method that enables one to control one or more process parameters of a combustion process so as to yield at least one desirable change in at least one downstream parameter. In one embodiment, the present invention is directed to a system and/or method for controlling at least one process parameter of a combustion process so as to yield at least one desirable change in at least one downstream process parameter associated with one or more of a wet flue gas desulfurization (WFGD) unit, a particulate collection device and/or control of additives thereto and/or a nitrogen oxide control device and/or control of additives thereto and/or additives to the system. In another embodiment, the present invention is directed to a system and/or method for controlling at least two process parameters of a combustion process so as to yield at least one desirable change in at least one downstream process parameter associated with one or more of a wet flue gas desulfurization (WFGD) unit, a particulate collection device and/or control of additives thereto and/or a nitrogen oxide control device and/or control of additives thereto and/or additives to the system. In still another embodiment, the present invention relates to measuring or determining at least one process parameter of a combustion system and using the information obtained from same to control at least one component of the combustion system.

Accordingly, one aspect of the present invention is drawn to a method for optimizing a wet flue gas desulfurization unit, the method comprising the steps of: (I) measuring, analyzing and/or controlling at least one parameter selected from: (a) a type and/or an amount of fuel to be combusted in a combustion process; (h) oxidation air flow rate to the combustion process; (c) an ammonia slip across a selective catalytic reduction unit; (d) a nitrogen oxide output from the selective catalytic reduction unit; (e) a particulate control and/or capture device parameter; (f) mercury speciation in the flue gas and/or absorber tank; (g) selenium speciation in the flue gas and/or absorber tank; (h) chemistry in the flue gas and/or absorber tank of the WFGD; (i) an oxidation-reduction potential of the absorber tank of the WFGD: (j) an amount of suspended solids in the absorber tank of the wet flue gas desulfurization unit; (k) an analysis of limestone and/or lime utilized in the wet flue gas desulfurization unit; (I) an amount of one or more reagents supplied to the wet flue gas desulfurization unit tower; (m) SO₂ concentration at the flue gas inlet of the wet flue gas desulfurization unit; (n) inlet opacity of the wet flue gas desulfurization unit: (o) PI data from the wet flue gas desulfurization unit; (p) an amount of dissolved solids in the wet flue gas desulfurization unit; and/or (q) relative saturation of the gypsum crystals in the wet flue gas desulfurization unit; (II) generating data from the at least one parameter of Step (I); (III) using the data generated in Step (II) to adjust at least one operational parameter selected from: (A) operational wet flue gas desulfurization unit tower level; (B) reagent feed flow to the wet flue gas desulfurization unit; (C) oxidation air flow to the wet flue gas desulfurization unit; (D) rate of absorber bleed from the wet flue gas desulfurization unit; (E) liquid to gas ratio in the wet flue gas desulfurization unit tower; (F) number of operating absorber recycle pumps in the wet flue gas desulfurization unit; (G) one or more dewatering operation parameters; (H) ammonia feed rate to the selective catalytic reduction unit; (I) gypsum purity; (J) gypsum-related scale formation in the wet flue gas desulfurization unit absorber tower; (K) parasitic power loss by the wet flue gas desulfurization unit equipment; (L) oxidation-reduction potential in the absorber recirculation tank; (M) wet flue gas desulfurization unit effluent stream waste water treatment parameters; (N) SO₂ removal efficiency by the wet flue gas desulfurization unit; (O) relative saturation of the gypsum crystals in the slurry; and/or (P) total dissolved solids in the wet flue gas desulfurization unit.

In yet another aspect of the present invention, there is provided a method for optimizing a wet flue gas desulfurization unit, the method comprising the steps of: (i) measuring, analyzing and/or controlling at least one parameter in real time selected from: (a) a type and/or an amount of fuel to be combusted in a combustion process; (b) an oxidation air flow rate to the combustion process; (c) ammonia slip across a selective catalytic reduction unit; (d) the nitrogen oxide output from the selective catalytic reduction unit; (e) a particulate control and/or capture device parameter; (f) mercury speciation in the flue gas and/or absorber tank; (g) selenium speciation in the flue gas and/or absorber tank; (h) chemistry in the flue gas and/or absorber tank of the WFGD; (i) an oxidation-reduction potential of the absorber tank of the WFGD; (j) an amount of the suspended solids in the absorber tank of the wet flue gas desulfurization unit; (k) an analysis of limestone and/or lime utilized in the wet flue gas desulfurization unit; (l) an amount of one or more reagents supplied to the wet flue gas desulfurization unit tower; (m) SO₂ concentration at the flue gas inlet of the wet flue gas desulfurization unit; (n) inlet opacity of the wet flue gas desulfurization unit; (o) PI data from the wet flue gas desulfurization unit; (p) an amount of dissolved solids in the wet flue gas desulfurization unit; and/or (q) relative saturation of the gypsum crystals in the wet flue gas desulfurization unit; (ii) generating real-time data from the at least one parameter of Step (I); (iii) using the real-time data generated in Step (ii) to adjust at least one operational parameter selected from: (A) operational wet flue gas desulfurization unit tower level; (B) reagent feed flow to the wet flue gas desulfurization unit; (C) oxidation air flow to the wet flue gas desulfurization unit; (D) rate of absorber bleed from the wet flue gas desulfurization unit; (E) liquid to gas ratio in the wet flue gas desulfurization unit tower; (F) number of operating absorber recycle pumps in the wet flue gas desulfurization unit; (G) one or more dewatering operation parameters; (H) ammonia feed rate to the selective catalytic reduction unit; (I) gypsum purity; (J) gypsum-related scale formation in the wet flue gas desulfurization unit absorber tower; (K) parasitic power loss by the wet flue gas desulfurization unit equipment; (L) oxidation-reduction potential in the absorber recirculation tank; (M) wet flue gas desulfurization unit effluent stream waste water treatment parameters; (N) SO₂ removal efficiency by the wet flue gas desulfurization unit; (O) relative saturation of the gypsum crystals in the slurry; and/or (P) total dissolved solids in the wet flue gas desulfurization unit.

In yet another aspect of the present invention, there is provided a method for optimizing a wet flue gas desulfurization unit, the method comprising the steps of: controlling, measuring and/or analyzing at least one process parameter of a combustion process and/or at least one combustion process air quality control system in order to yield at least one data set; using the at least one data set to effect a desirable change in at least one downstream process parameter associated with one or more of a wet flue gas desulfurization unit, a particulate collection device and/or a nitrogen oxide control device.

In yet another aspect of the present invention, there is provided a method for optimizing a wet flue gas desulfurization unit, the method comprising the steps of; controlling, measuring and/or analyzing at least two process parameters of a combustion process and/or at least one combustion process air quality control system in order to yield at least one data set; using the at least two data sets to effect a desirable change in at least one downstream process parameter associated with one or more of a wet flue gas desulfurization unit, a particulate collection device and/or a nitrogen oxide control device.

In yet another aspect of the present invention, there is provided a method for optimizing a wet flue gas desulfurization unit, the method comprising the steps of: measuring, analyzing and/or controlling at least one parameter selected from: (i) desulfurization tower load; (ii) oxidation air flow rate: (iii) one or more boiler parameters; (iv) one or more selective catalytic reduction unit parameters; and/or (v) one or more electrostatic precipitator parameters; generating data from the at least one parameter of the previous Step; and using the data generated in the previous Step to adjust at least one operational parameter selected from: (a) one or more gypsum production properties and/or parameters; (b) oxidation-reduction potential in the absorber recirculation tank; (c) pH of the absorber recirculation tank solution; (d) a concentration, type and/or speciation of one or more compounds and/or ions in the absorber recirculation tank solution; and/or (e) a concentration, type and/or speciation of one or more oxidizer compounds and/or ions in the absorber recirculation tank solution and/or the wet flue gas desulfurization unit.

In yet another aspect of the present invention, the present invention relates generally to the generation of steam via the use of a combustion process to produce heat and, in one embodiment, to a device, system and/or method that enables one to control one or more process parameters of a combustion process so as to yield at least one desirable change in at least one downstream parameter. In another embodiment, the present invention relates to a device, system and/or method for controlling and/or optimizing the performance of a DSI, ACI, WSI, WI and/or ESP by measuring, analyzing and/or controlling at least one or more operating parameters in real time, These parameters include, but are not limited to, boiler load, ESP power, ESP current, ESP voltage, opacity, particulate, ESP spark rate, SO₃ measurement, SO₂ measurement, O₂ measurement, ash resistivity measurement. VOC measurement, air heater outlet temperature, air heater speed, SCR inlet temperature, SCR outlet temperatures, SCR catalyst SO₂ to SO₃ conversion rates, flue gas weights, flue gas flow, injection rates for DSI, injection rate for WSI, injection rates for ACI, and Hg emissions.

Accordingly, one aspect of the present invention is drawn to a device, system and/or method that permits, as disclosed and described herein, one to control and/or optimize the performance of one or more of a DSI, ACI, WSI, WI and/or ESP by measuring, analyzing and/or controlling one or more operating parameters in real time.

In yet another aspect of the present invention, there is provided a device, system and/or method that permits, as disclosed and described herein, one to control and/or optimize the performance of one or more of a DSI, ACI, WSI, WI and/or ESP by measuring, analyzing and/or controlling one or more operating parameters in real time, where the operating parameters are selected from boiler load, ESP power, ESP current, ESP voltage, opacity, particulate, ESP spark rate, SO₃ measurement, SO₂ measurement, O₂ measurement, ash resistivity measurement, VOC measurement, air heater outlet temperature, air heater speed, SCR inlet temperature, SCR outlet temperatures, SCR catalyst SO₂ to SO₃ conversion rates, flue gas weights, flue gas flow, injection rates for DSI, injection rate for WSI, injection rates for ACI, and Hg emissions, or combinations of any two or more thereof.

In yet another aspect of the present invention, there is provided a method for optimizing one or more components of a combustion system, the method comprising the steps of: (I) measuring, collecting and/or analyzing data from at least one parameter selected from: (a) a load, a fuel supply rate, and/or one or more fuel conditions of a boiler; (b) inlet SO₂ concentration or level prior to entry of the flue gas into a WFGD unit; (c) WFGD tower level; (d) WFGD unit pH level; (e) absorber recirculation tank ORP; (f) WFGD effluent ORP from an ART of the WFGD: (g) outlet SO₂ concentration or level contained in a treated flue gas exiting from a WFGD unit; (h) flue gas O₂ content, concentration and/or level as measured upon exit of the flue gas from a boiler or furnace; (i) reagent injection rate for a NO control device; (j) outlet NO, level and/or concentration in the flue exiting either the NO, control device; (k) injection rate of one or more sorbents in one or more DSI injection units; (l) sulfur concentration and/or the type of sulfur compound present as the flue gas exits a DSI unit; (m) spark rate and/or power level of an ESP unit, primary and/or secondary ESP voltage, primary and/or secondary ESP current, and/or ESP gas flux, or if particulate control device is achieved by some other type of particulate control device than one or more operating parameters associated therewith; and/or (n) mercury level, concentration and or type in the flue gas exiting a WFGD unit; (II) generating data from the at least one parameter of Step (I); and (III) using the data generated in Step (II) to adjust at least one operational parameters of one or more components of a combustion system selected from a boiler or furnace, one or more NOₓ control devices, one or more DSI units, one or more particulate control units; one or more WFGD units, one or more waste water treatment devices, or any combination of two or more thereof.

In one instance the one or more parameters that are adjusted in Step (III) of the method immediately above include one or more of: (i) an oxidation air supply rate to the one or more WFGD units; (ii) limestone, lime and/or slaked lime supply rate to the one or more WFGD units; (iii) any one or more fuel additive injection rates and/or concentrations; (iv) combustion control bias of the boiler or furnace; (v) one or more NOₓ control device parameters, control and/or NH₃ injection rate bias, control and/or urea injection rate bias; (vi) DSI injection rate, type and/or concentration and/or SO₃ concentration; (vii) PAC injection rate and/or type; (viii) particulate control unit bias and/or control of other particulate unit process parameters; (ix) WFGD additive injection rate, concentration and/or type; (x) additive injection rate, concentration and/or type as supplied to any injection point in the combustion system; and/or (xi) any waste water treatment unit and/or system parameter.

The various features of novelty which characterize the invention are pointed out with particularity in the claims annexed to and forming a part of this disclosure. For a better understanding of the invention, its operating advantages and specific benefits attained by its uses, reference is made to the accompanying drawings and descriptive matter in which exemplary embodiments of the invention are illustrated.

### BRIEF DESCRIPTION OF THE DRAWINGS

FIG. 1 is chart detailing one typical effect of SO₃ on the amount of PAC required to meet a desired level of mercury (Hg) control and/or capture;

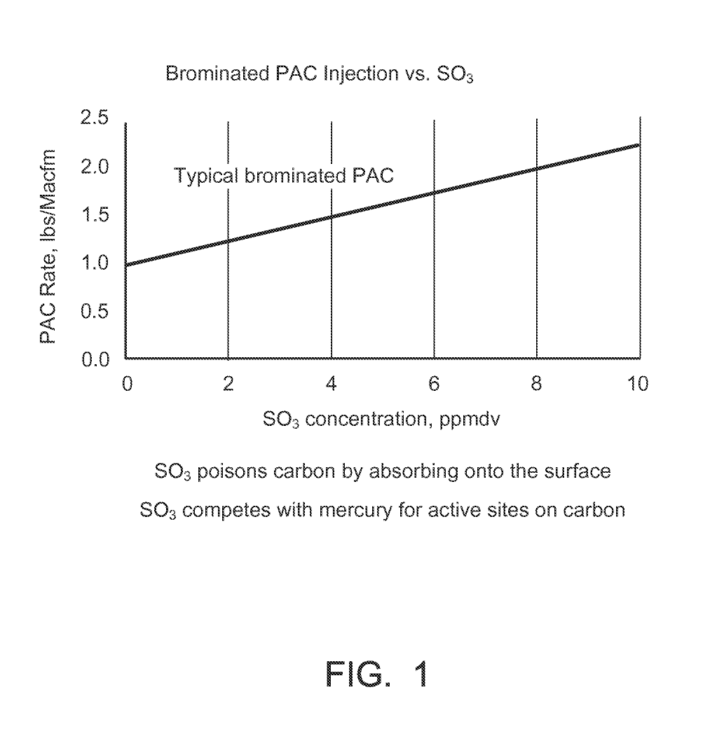

FIG. 2A is an top down view of one type of typical DSI distribution grid;

FIG. 2B is a side view of one type of typical DSI distribution grid; and

FIG. 3 is an illustration of a fossil fuel-fired boiler system having one or more possible primary and/or secondary inputs that are used to provide information and/or feedback to one or more optimizer and/or controllers of the present invention thereby enabling the method of the present invention to output one or more primary and/or secondary control signals to achieve optimization of the fossil fuel-fired boiler system and/or one or more AQCS devices associated therewith.

### DESCRIPTION OF THE INVENTION

The present invention relates generally to the generation of steam via the use of a combustion process to produce heat and, in one embodiment, to a device, system and/or method that enables one to control one or more process parameters of a combustion process so as to yield at least one desirable change in at least one downstream parameter. In one embodiment, the present invention is directed to a system and/or method for controlling at least one process parameter of a combustion process so as to yield at least one desirable change in at least one downstream process parameter associated with one or more of a wet flue gas desulfurization (WFGD) unit, a particulate collection device and/or control of additives thereto and/or a nitrogen oxide control device and/or control of additives thereto and/or additives to the system. In another embodiment, the present invention is directed to a system and/or method for controlling at least two process parameters of a combustion process so as to yield at least one desirable change in at least one downstream process parameter associated with one or more of a wet flue gas desulfurization (WFGD) unit, a particulate collection device and/or control of additives thereto and/or a nitrogen oxide control device and/or control of additives thereto and/or additives to the system. In still another embodiment, the present invention relates to measuring or determining at least one process parameter of a combustion system and using the information obtained from same to control at least one component of the combustion system.

In one embodiment, the present invention the system and/or method of the present invention includes controlling and/or monitoring one or more of: (i) desulfurization tower load; (ii) oxidation air flow rate; (iii) one or more boiler parameters; (iv) one or more selective catalytic reduction (SCR) unit parameters; and (v) one or more parameters of the particulate collection device (e.g., the electrostatic precipitator (ESP)).

Given the above, a more detailed discussion of each of the above parameters will be discussed herein below. Turning to parameter (i), in one embodiment the system and/or method of the present invention involves analyzing, controlling and/or monitoring the tower load of a desulfurization unit (e.g., a wet flue gas desulfurization unit (WFGD)) via analyzing, controlling and/or monitoring one or more of the megawatt load being generated by the boiler unit; the SO₂ removal rate; and/or the inlet SO₂ amount present at at least one inlet to the desulfurization unit.

Turning to parameter (ii), in one embodiment the system and/or method of the present invention involves analyzing, controlling and/or monitoring the amount, flow rate and/or type of the oxidation air that is supplied to a desulfurization unit (e.g., a wet flue gas desulfurization unit (WFGD)). While not wishing to be bound to any one theory, it is believed that by analyzing, controlling and/or monitoring the amount, flow rate and/or type of the oxidation air that is supplied to a desulfurization unit it is possible to control the production of sulfite compounds and/or species in the flue gas as well as in the desulfurization unit. This in turn is believed to impact the formation of other strong oxidizers as sulfite ions are known to act as reducing agents in a flue gas and/or desulfurization unit environment. Furthermore, the production of sulfite ions and/or species can have an impact on the production and/or presence of any ozone that may occur due to the operation of any one or more particulate collection devices (e.g., an electrostatic precipitator). Additionally, via the control of the amount and/or concentration of various types of sulfite species and/or ions, it is possible to control the calcium sulfite to calcium sulfate conversion rate which in turn permits one to control the gypsum production rate and/or purity of the WFGD.

Turning to parameter (iii), in one embodiment the system and/or method of the present invention involves analyzing, controlling and/or monitoring various boiler parameters. Such parameters include, but are not limited to, fuel supply rate, oxidation air supply rate, overfire air supply rate, type of fuel, fuel composition, fuel type, fuel impurities, etc. Given the analysis, control and/or monitoring of one or more of the above noted boiler parameters, various resulting downstream parameters or downstream process parameters can be controlled. While not wishing to be bound to any one theory and/or downstream process parameters that can be controlled, it is then possible via the control of one or more of the above noted boiler parameters to impact the ORP in, for example, a recirculation tank of a wet scrubber (also referred to as an absorber recirculation tank or ART). This in turn permits the control and/or mitigation of various corrosion issues that occur when the ORP in an ART becomes undesirable. Additionally, the analysis, control and/or monitoring of one or more boiler parameters can permit the control of ash resistivity.

As used herein, “ash resistivity” refers to the resistivity of the ash to accept a charge. The ash resistivity affects the ability of the particulate collection device, and in particular, an electrostatic precipitator, to efficiently complete its assigned task (that is the collection of particulate material from a flue gas). Additionally, the boiler parameters also have an impact on the operating conditions of any SCR that might be utilized to remove nitrous oxides from the flue gas. Given the above, the boiler parameters can indirectly impact the amount of ozone that may be produced by an ESP as the boiler parameters impact the amount and/or type of ash that is produced by the combustion process. The ash type and/or amount in turn influences the operating conditions that are necessary in the ESP to collect said ash. For example, if an ESP has to operate at a high power and/or at a higher sparking rate to obtain a higher power in order to adequately collect the ash in the flue gas, such conditions can lead to an increase in the production of ozone in the flue gas.

While not wishing to be bound to any one theory, it is believed that an increase in the concentration (or amount) of ozone in the flue gas leads to an undesirable change in the ORP in an ART (this is of course in the case where the flue gas desulfurization unit is a WFGD). This is because ozone is a strong oxidizer. Thus, the boiler parameters indirectly impact the amount of ozone generated via the impact such parameters have on ash resistivity. This is true in most cases but may not generate and/or yield the same results and/or impact on ozone production and/or ESP parameters if one or more additives added to the coal prior to the coal being supplied to the burners and/or any additives are added to the boiler and/or flue gas stream upstream (i.e., the hot side) of the SCR.

Turning to parameter (iv), in one embodiment the system and/or method of the present invention involves analyzing, controlling and/or monitoring various SCR parameters, Such parameters include, but are not limited to, the ammonia slip across the selective catalytic reduction (SCR) unit and/or the nitrogen oxide output from a SCR. It is believed that such parameters can impact the ORP in the ART. In one embodiment, the control of one or more boiler parameters is more important in the control of the ORP in the ART than it is to control various SCR parameters. In another embodiment, it is more important to control the SCR parameters instead of the boiler parameters in order to achieve the desired ORP control. In yet another embodiment, the desired control of the ORP in the ART is achieved by controlling any various combination of at least one boiler parameter in combination with at least one SCR parameter.

Turning to parameter (v), in one embodiment the system and/or method of the present invention involves analyzing, controlling and/or monitoring various ESP parameters. As would be apparent to those of skill in the art, this factor applies only if there is an ESP present in the air quality control systems attached to the combustion process in question. In one embodiment, the ESP parameters that are analyzed, controlled and/or monitored include, but are not limited to. ESP power, ESP voltage, ESP amps and/or ESP sparking rate.

As noted above, ESP power and/or ESP sparking rate is a function of ash resistivity. Ash resistivity may also be influenced by other factors including, but not limited to. ESP power supply and/or controller, and/or gas flux. These factors may have to be considered in addition to, or in place of, the ESP power and/or ESP sparking rate issues discussed above. In one instance, it may be necessary to increase either one or both of ESP power and/or ESP sparking rate to achieve a desired level of ash removal if the ash has a high resistivity to the acceptance of a charge. The higher the ESP power and/or ESP sparking rate, the higher the ozone production rate and/or concentration. Additionally, another factor that may need to be considered in the realm of ozone formation is “back corona effect” as is known to those of skill in the art. This in turn leads to a higher ORP in the ART do to either the direct impact of an increase in the concentration of ozone or some chemical and/or species generated by ozone reacting with another species or compound present in the flue gas. The injection SO₃, sodium sorbents, wet or dry sorbents such as trona (i.e., trisodium hydrogendicarbonate which can also be written in its hydrated form as Na₃(CO₃)(HCO₃).2H₂O or Na₂CO₃.NaHCO₃.2H₂O) and/or hydrated lime seems to impact the formation of ozone in the ESP. It should be noted that the term “trona” is to be broadly construed and is not solely limited to just the hydrated state detailed above.

While not wishing to be bound to any one theory, it is believed that the injection of one or more of the above compounds affects ash resistivity and thus impacts either positively or negatively the amount of ozone generated by the power and sparking in the ESP. As such, in one embodiment the present invention encompasses the analysis, control and/or monitoring of the type of materials injected into the flue gas stream to determine the impact of such compounds on ash resistivity. As noted above, an increase in ash resistivity can lead to an increase in ozone production because it becomes necessary to increase either one or both of ESP power and/or ESP sparking rate in order to achieve the desired level of ash removal as the ash becomes more resistive to accepting a charge. This in turn can, as noted above, result an undesired change in the ORP of an ART due to the presence of an increased amount of ozone and/or an increase in various reaction products formed due to the interaction of various flue gas constituents with the increased level of ozone.

Given the above, the one or more analyses, control measures, measurements and/or determinations of the various parameters listed above can permit the control and/or optimization of one or more of the following: (a) one or more gypsum production properties and/or parameters including, but not limited to, gypsum purity, gypsum moisture content and/or gypsum mass flow; (b) the oxidation-reduction potential (ORP) in the absorber recirculation tank (ART); and (c) the pH of the ART solution. The ORP in the ART can be measured, monitored and/or determined by the ORP in mV or a sensor designed to measure and/or monitor the oxidizer content in the ART solution. The ORP in turn can influence various parameters including, but not limited to, the aqueous species in the ART solution such as selenium, cobalt, manganese, mercury, arsenic, as well as potentially any other trace elements that might be in coal that might be regulated now or in the near future. Regarding the pH of the ART solution, the pH of this solution can be measured by various known methods including, but not limited to, titration, pH meters, etc.

In another embodiment, the system and/or method of the present invention includes controlling and/or monitoring one or more of: (I) the type and/or amount of fuel to be combusted in the combustion process (e.g., fossil fuel type such as coal type); (II) the oxidation air flow rate to the combustion process; (III) the ammonia slip across the selective catalytic reduction (SCR) unit, if present; (IV) the nitrogen oxide output from a SCR, if present; (V) the particulate control and/or capture device (e.g., electrostatic precipitator (ESP)) including, but not limited to, one or more particulate collection device operating parameters; the additives to the ESP system including, but not limited to, ash condition agents including but not limited to sulfur species; system additives injected for SO₃ mitigation: (VI) the mercury speciation in the flue gas and/or absorber tank; (VII) the selenium speciation in the flue gas and/or absorber tank; (VIII) the chemistry in the flue gas and/or absorber tank of the WFGD; (IX) the oxidation-reduction potential (ORP) of the absorber tank of the WFGD; the pH within the absorber tank; (X) the amount of the suspended solids (SS) in the absorber tank of the WFGD; (XI) the analysis of the limestone and/or lime utilized in the WFGD; (XII) the amount of various reagents supplied to the WFGD tower; (XIII) the SO₂ concentration at the flue gas inlet of the WFGD; (XIV) the inlet opacity of the WFGD; and/or (XV) the PI data from the WFGD.

Given the above, a more detailed discussion of each of the above parameters will be discussed herein below. Turning to parameter (I), in one embodiment the system and/or method of the present invention involves analyzing, controlling and/or monitoring the type and/or amount of fuel to be combusted in the combustion process (e.g., fossil fuel type such as coal type). In the case where an analysis of this parameter is utilized the analysis of the fuel to be combusted can be accomplished by any one or more known analysis techniques including, but not limited to, gas chromatography, liquid chromatography, gas chromatography-mass spectroscopy (GC-MS), mass spectroscopy, NMR analysis, FTIR, flame analysis, etc. In another embodiment, the analysis of the fuel to be combusted can be accomplished by utilizing any two or more of the above-mentioned techniques. When utilized, the analysis of the fuel to be combusted can involve analyzing the heating value, the amount of phosphorus, hydrogen, chlorine, fluorine, sulfur, one or more heavy metals (e.g., mercury, cadmium, selenium, etc.), moisture content, ash content, carbon content, mineral content (e.g., pyrite).

Alternatively, the amount of sulfur and/or phosphorus in a combustion gas can be ascertained utilizing one or more sensors or probes designed to measure the amount of gas-phase sulfur and/or gas-phase phosphorus. Since such probes are known to those of skill in the art, a detailed discussion herein is omitted for the sake of brevity. As would be apparent to those of skill in the art, any probes and/or sensors utilized in connection with the various systems and/or methods of the present invention can be placed at one or more locations in a steam generation combustion process including, but not limited to, the boiler, the combustion zone of the boiler, the economizer, the air heater (if present), the SCR or SNCR (if present), the particulate control device (e.g., a ESP or bag house), and/or the WFGD. It should be noted that the above positions are exemplary in nature and the present invention is not limited to solely the above-listed locations. Rather, any location within a steam generation system can be utilized where any one more sensors, or probes, located therein yield at least one piece of useful data. Additionally, any of the analyses discussed herein can, if so possible, be accomplished in real-time if a suitable sensor, or probe, is available to measure and/or analyze the desired given parameter, or parameters.

Turning to parameter (II), in one embodiment the system and/or method of the present invention involves analyzing, controlling and/or monitoring the oxidation air flow rate to the combustion process, In this embodiment, such an analysis can be accomplished by the use of a flow meter or other system that permits one to ascertain the amount of oxidation air that is being supplied to a combustion process. Alternatively, a metering system can be utilized so as to permit one to determine the amount of oxidation air that is being supplied to a combustion process. In another embodiment, various other systems and/or methods are known to those that permit the metering and/or measurement of a gas being supplied to a process and can be utilized herein to determine the amount of oxidation air being supplied to a combustion process. It should be noted that some combustion process might not utilize a discrete oxidation air supply. In this instance, the analyses of the amount of oxidation air being supplied to a combustion process would be omitted but might instead involve ORP and/or dissolved oxygen measurements.

Turning to parameter (III), in one embodiment the system and/or method of the present invention involves analyzing, controlling and/or monitoring the ammonia slip across the selective catalytic reduction (SCR) unit, if so present. As would be known to those of skill in the emissions control arts, systems and/or methods for determining the amount ammonia slip across an SCR are known in the art and any such system and/or method can be utilized in conjunction with the present invention to obtain data relating to the amount of ammonia slip across the SCR. Since such systems and/or methods are known in the art, a detailed discussion herein is omitted for the sake of brevity.

Turning to parameter (IV), in one embodiment the system and/or method of the present invention involves analyzing, controlling and/or monitoring the nitrogen oxide output from a SCR, if present. As would be known to those of skill in the emissions control arts, systems and/or methods for determining the amount nitrogen in a gas are known in the art and any such system and/or method can be utilized in conjunction with the present invention to obtain data relating to the amount and/or concentration of nitrogen and/or nitrogen-containing compounds in a gas. Since such systems and/or methods are known in the art, a detailed discussion herein is omitted for the sake of brevity.

Turning to parameter (V), in one embodiment the system and/or method of the present invention involves analyzing, controlling and/or monitoring the operating parameters of one or more particulate control and/or capture devices (e.g., electrostatic precipitator (ESP)). Such operating parameters can include, but are not limited to, power input, spark rate, volts, amps, etc. Such operating parameters also include additives to or upstream of the ESP, including but not limited to fly ash conditioning agents, including but not limited to injection of sulfur species.

Turning to parameter (VI), in one embodiment the system and/or method of the present invention involves analyzing, controlling and/or monitoring the mercury speciation in the flue gas and/or absorber tank. As would be known to those of skill in the emissions control arts, systems and/or methods for determining the type of mercury species in a flue gas are known in the art and any such system and/or method can be utilized in conjunction with the present invention to obtain data relating to the type, amount and/or concentration of various mercury species in a gas. Suitable methods can include, but are not limited to, titration, liquid chromatography, gas chromatography-mass spectroscopy (GC-MS), mass spectroscopy, NMR analysis, FTIR, flame analysis, and/or inference from the analysis of the ORP in the ART. Since such systems and/or methods are known in the art, a detailed discussion herein is omitted for the sake of brevity.

Turning to parameter (VII), in one embodiment the system and/or method of the present invention involves analyzing, controlling and/or monitoring the selenium speciation in the flue gas and/or absorber tank. As would be known to those of skill in the emissions control arts, systems and/or methods for determining the type of selenium species in a flue gas are known in the art and any such system and/or method can be utilized in conjunction with the present invention to obtain data relating to the type, amount and/or concentration of various selenium species in a gas. Suitable methods can include, but are not limited to, titration, liquid chromatography, gas chromatography-mass spectroscopy (GC-MS), mass spectroscopy, NMR analysis, FTIR, flame analysis, and/or inference from the analysis of the ORP in the ART. Since such systems and/or methods to accomplish same are known in the art, a detailed discussion herein is omitted for the sake of brevity.

Turning to parameter (VIII), in one embodiment the system and/or method of the present invention involves analyzing, controlling and/or monitoring the chemistry in the flue gas and/or absorber tank of the WFGD. As would be known to those of skill in the emissions control arts, systems and/or methods for determining various chemical and/or physical parameters in the solution of an absorber tank of a WFGD are known to those of skill in the art. Exemplary chemical and/or physical parameters that can be analyzed include, but are not limited to, the pH of the absorber tank solution, the specific gravity of the absorber tank solution, the viscosity of the absorber tank solution, the opacity of the absorber tank solution, the total suspended solids in the absorber tank solution, the recirculation rate of the solution in the absorber tank, and/or the presence of one or more aqueous species in the absorber tank (e.g., persulfate species concentration and/or type, one or more oxidizer species and/or concentration, chloride concentration, fluoride concentration, calcium concentration, sulfur-oxygen compounds, sulfur-nitrogen compounds, magnesium species concentration and/or type, mercury concentration, selenium concentration and type). Here, as well as elsewhere in the specification and claims, the term “oxidizer” includes, but not limited to, persulfate, permanganate, manganate, ozone, hypochlorite, chlorate, nitric acid, iodine, bromine, chlorine, fluorine, or combinations of any two or more thereof. Here, as well as elsewhere in the specification and claims, the term “persulfate” is defined to include one or both of peroxodisulfate ions (S₂O₈²⁻) or peroxornonosulfate ions (SO₅²⁻). Accordingly, as used throughout the specification and claims the term “persulfate” includes both persulfate ions and other forms of the noted ionic compounds above regardless of whether such ions are bound in a chemical composition or in an ionic state because they are in solution.

Regarding the above one or more parameters to be measured and/or analyzed, suitable methods can include, but are not limited to, titration, liquid chromatography, gas chromatography-mass spectroscopy (GC-MS), mass spectroscopy, NMR analysis, FTIR, and/or flame analysis. Since such systems and/or methods to accomplish same are known in the art, a detailed discussion herein is omitted for the sake of brevity.

Turning to parameter (IX), in one embodiment the system and/or method of the present invention involves analyzing, controlling and/or monitoring the oxidation-reduction potential (ORP) of the absorber tank of the WFGD. Such a determination of the ORP of the absorber tank solution can be accomplished by a variety of methods including, but not limited to, determining the concentration of various aqueous species (e.g., one or more oxidizer species concentration and/or type, persulfate species concentration and/or type, magnesium species concentration and/or type, chloride concentration, fluoride concentration, calcium concentration, sulfur-oxygen compounds, sulfur-nitrogen compounds, magnesium species concentration and/or type, mercury concentration, selenium concentration and type). Regarding the above one or more aqueous species to be measured and/or analyzed, suitable methods can include, but are not limited to, titration, liquid chromatography, gas chromatography-mass spectroscopy (GC-MS), mass spectroscopy, NMR analysis, FTIR, measurement of the conductivity of the absorber tank solution, oxidation-reduction potential measurements, and/or flame analysis. Since such systems and/or methods to accomplish same are known in the art, a detailed discussion herein is omitted for the sake of brevity.

Turning to parameter (X), in one embodiment the system and/or method of the present invention involves analyzing, controlling and/or monitoring the suspended solids (SS), or even total suspended solids (TSS), in the absorber tank of the WFGD. Such measurements can be accomplished by a variety of known techniques and/or systems including, but not limited to, turbidity and/or opacity measurements, gravimetric methods, etc,

Turning to parameter (XI), in one embodiment the system and/or method of the present invention involves analyzing, controlling and/or monitoring the limestone and/or lime utilized in the WFGD. Such an analysis can include, but is not limited to, a compositional analysis, the amount of limestone and/or lime being supplied to the WFGD via one or more techniques including, but not limited to, titration, liquid chromatography, gas chromatography-mass spectroscopy (GC-MS), mass spectroscopy, NMR analysis, FTIR, measurement of the conductivity of the absorber tank solution, oxidation-reduction potential measurements, and/or flame analysis. Since such systems and/or methods to accomplish same are known in the art, a detailed discussion herein is omitted for the sake of brevity.

Turning to parameter (XII), in one embodiment the system and/or method of the present invention involves analyzing, controlling and/or monitoring the amount of various reagents supplied to the WFGD tower. Such reagents include, but are not limited to, water, pH buffer, reducing agents, oxidizing agents, organic acids, or mixtures of two or more thereof. Such an analysis can include, but is not limited to, a compositional analysis, purity analysis, etc. supplied to a WFGD via one or more techniques including, but not limited to, titration, liquid chromatography, gas chromatography-mass spectroscopy (GC-MS), mass spectroscopy, NMR analysis, FTIR, measurement of the conductivity of the absorber tank solution, oxidation-reduction potential measurements, and/or flame analysis. Since such systems and/or methods to accomplish same are known in the art, a detailed discussion herein is omitted for the sake of brevity.

Turning to parameter (XIII), in one embodiment the system and/or method of the present invention involves analyzing, controlling and/or monitoring the SO₂ concentration at the flue gas inlet of the WFGD. As would be known to those of skill in the emissions control arts, systems and/or methods for determining the amount of SO₂ in a gas are known in the art and any such system and/or method can be utilized in conjunction with the present invention to obtain data relating to the amount and/or concentration of SO₂ in a gas. Since such systems and/or methods are known in the art, a detailed discussion herein is omitted for the sake of brevity.

Turning to parameter (XIV), in one embodiment the system and/or method of the present invention involves analyzing, controlling and/or monitoring the inlet opacity of the WFGD. Such an analysis can be accomplished by a variety of methods including, but not limited to, transmissometer opacity measurements, etc. Turning to parameter (XV), in one embodiment the system and/or method of the present invention involves analyzing the PI data from the WFGD.

Additionally, as noted above, any of the analyses discussed herein can, if so possible, be accomplished in real-time if a suitable sensor, or probe, is available to measure and/or analyze the desired given parameter, or parameters. In the case where real time data is desired at least one computer and/or computational system can be utilized in conjunction with the present invention. Such computer systems and/or computational devices are known to those of skill in the art and as such a discussion herein is omitted for the sake of brevity.

Given the above, the one or more analyses, control measures, measurements and/or determinations of the various parameters listed above can permit the control and/or optimization of one or more of the following: (A) operational WFGD tower level; (B) reagent feed flow to the WFGD; (C) oxidation air flow to the WFGD; (D) rate of absorber bleed from the WFGD; (E) liquid to gas ratio in the WFGD tower; (F) the number of operating absorber recycle pumps in the WFGD; (G) dewatering (hydroclone) operation parameters; (H) ammonia feed rate to the SCR (if present); (I) the number of ESP fields in operation; (J) gypsum purity; (K) gypsum-related scale formation in the WFGD absorber tower; (L) parasitic power loss by the WFGD equipment; (M) WFGD effluent stream waste water treatment parameters; and (N) SO₂ removal efficiency by the WFGD.

This system and/or method of the present invention can, in one embodiment, achieve a more responsive control system which will allow the WFGD system to function better during times of non-steady state operation by the boiler. More and more, coal fired utilities are swinging boiler load to allow for steady power grid operation. A more responsive control system may lead to better tower chemistry thereby achieving an improvement in SO₂ removal efficiency.

As an example of one such non-limiting parameter and/or operating condition that can be measured and therefore controlled is the ORP level of the solution in an absorber tank of a WFGD. Controlling ORP to a pre-determined range and steady state condition can help mitigate corrosion potential in the tower as well as to control elemental vapor phase mercury formation and reemission. An optimization program that will help to control the SCR and ESP parameters may lead to less ammonia injection and less power requirement by the ESP. An optimization program has the potential to mitigate parasitic power loss of the equipment.

In one embodiment, the system and/or method of the present invention involves flue gas testing that is accomplished by continuous Fourier Transform infrared Spectroscopy (FTIR) monitoring for all gas species and carbon trap mercury monitoring across the SCR and CEMS mercury testing at the SCR inlet during baseline testing and SCR testing weeks. Stack mercury analysis will be performed using sorbent traps in the stack during baseline testing. Chemical analysis of the absorber slurry will consist of speciated mercury, selenium and ICP-MS. Corrosion testing will also be conducted in isolated buckets wherein metal samples and Electrical Resistance (ER) probes would contact the process slurry. This testing will afford the opportunity for the plant to optimize the performance of these units.

As noted above, in one embodiment the present invention relates generally to the field of emissions control and, in particular to a new and useful method and/or system by which to control various types of corrosion and/or precipitation issues in at least a portion of a wet flue gas desulfurization (WFGD) scrubber system. In one embodiment, the method and/or system of the present invention relies on the supply of at least one reducing agent to the slurry of a wet flue gas desulfurization scrubber to lower the oxidation-reduction potential in the absorber slurry contained within the wet flue gas desulfurization scrubber. In still another embodiment, the method and/or system of the present invention control the oxidation-reduction potential in at least one bleed stream of an absorber slurry, filtrate, and/or solution from a wet flue gas desulfurization scrubber.

As discussed above, it has been determined that a high oxidation-reduction potential (ORP) and concentration of one or more oxidizer compounds and/or species (e.g., persulfate, permanganate, manganate, ozone, hypochlorite, chlorate, nitric acid, iodine, bromine, chlorine, fluorine, or combinations of any two or more thereof) in a wet scrubber's absorber recirculation tank (ART) causes precipitation of soluble manganese. While not wishing to be bound to any one theory, it is believed manganese dioxide precipitate (MnO₂) settling on the walls of the ART can create a galvanic cell leading to corrosion, or further enhancing the circumstances that cause corrosion. While not wishing to be bound to any one solution, one possible method to control, reduce and/or mitigate the ORP in an ART is to reduce the ORP by controlling, eliminating and/or reducing the concentration, or amount, of one or more oxidizer compounds and/or species (e.g., persulfate, permanganate, manganate, ozone, hypochlorite, chlorate, nitric acid, iodine, bromine, chlorine, fluorine, or combinations of any two or more thereof—in the form of ions, etc.) that exist in, or are formed in, the ART of a WFGD. While the present invention is described in terms of corrosion that occurs in an ART formed from Alloy 2205 (UNS S32205, a duplex stainless steel alloy), the present invention is not limited thereto. Rather, corrosion can and does occur in a wide range of iron-based alloys and as such, the present invention applies to any situation where the ORP needs to be controlled in order to reduce, control and/or mitigate the corrosive nature of the environment in an ART.

In still another embodiment, the present invention further includes the use of surplus oxidation air, regardless of where such surplus is generated, as a manner by which to control the various chemical properties of one or more aqueous-based solutions or liquids. This embodiment of the present invention can be achieved by supplying a desired amount of surplus oxidation air to one or more tanks containing any type of desired aqueous-based or liquid solutions via a least one supply method which include, but are not limited to, sparging, bubblers, etc.

In still yet another embodiment, the present invention permits the control of sparking in a particulate removal device (e.g., an electrostatic precipitator—ESP) which in turn permits the control of various factors that influence oxidizer formation. While not wishing to be bound to any one theory, one exemplary manner by which the ORP in an ART increases is due to the formation of ozone. Ozone formation can be traced to, among other things, an increase in sparking in an ESP. To prevent, control and/or mitigate the amount of sparking in an ESP an additive such as SO₃ and/or trona or other sodium sorbent, wet or dry, can be added upstream of an ESP. Alternatively, modification of the ESP controls may also be used to prevent, control and/or mitigate the amount of sparking in an ESP. Upon the addition of SO₃ and/or trona a decrease in ozone formation is observed due to a decrease in the amount of sparking in the ESP. This in turn allows for a more favorable ORP in the ART which in turn results in the ability to favorably control the nature of various aqueous species in the ART solution. Such species that can be controlled include, but are not limited to, oxidizer species concentration and type (e.g., persulfate species concentration and/or type), magnesium species concentration and/or type, chloride concentration, fluoride concentration, calcium concentration, sulfur-oxygen compounds, sulfur-nitrogen compounds, magnesium species concentration and/or type, mercury concentration, selenium concentration and type, or any two or more thereof.

One non-limiting example of the present invention was performed via field testing at the Detroit Edison (DTE) Monroe Power Plant in November and December of 2012. This testing was conducted to examine the effects of process changes upon wet flue gas desulfurization (WFGD) chemistry. According to one embodiment of the present invention, a parametric test plan to change coals, electrostatic precipitator (ESP) operation, ammonia slip to the SCR, WFGD oxidation air injection loading and the total suspended solids (TSS) of the WFGD absorber recirculation tank (ART) is investigated. Various parameters are measured and the results thereof are detailed in Tables 1 and 2 below, Of the parameters tested, modification of the SO₃ injection to the ESP has the most pronounced impact on WFGD absorber and effluent (WFGD bleed) stream chemistry.

The ESP at DTE Monroe is designed for operation with a mid-sulfur coal, 3.0 lbs/mBTU. DTE Monroe has switched to burning a lower-sulfur coal blend, with different physical characteristics, than that for which the air quality control system (AQCS) had been designed. SO₃ was injected into the ductwork upstream of the ESPs as a fly ash conditioning agent to improve ESP removal on the current coal. During testing at DTE Monroe, SO₃ injection prior to the ESP was shut off. One effect of the SO₃ injection in combination with the coal burned is that, for this system, one observes a decrease in spark rate within the ESP than would be expected without injection. Accordingly, when the SO₃ injection was turned off, ESP spark rate increased. Such an increase in spark rate likely causes an increase in ozone production within the WFGD, thereby increasing the concentration of downstream oxidizer(s). Other potential routes for increased oxidizer concentration within the flue gas may also be traced back to this increased sparking. Within a short period of time after shutting off the SO₃ injection, the ORP in the WFGD absorber reacting tank slurry increased by approximately 300 mV, changing the oxidation state and phase partitioning of many slurry constituents therein.

After the SO₃ injection was restarted, the ORP of the WFGD slurry slowly returned to the lower levels that had been exhibited during baseline testing. This return to baseline conditions occurred slowly and with a pattern consistent with residence time decay. None of the other parameters tested exhibited such a pronounced and dramatic change in scrubber chemistry. This parametric change of turning off the SO₃ to the ESP has since been replicated in both operating absorber towers (Units 3 & 4) at DTE Monroe at least twice, all times exhibiting a similar response to the change. Accordingly, given the above, in one embodiment the present invention seeks to utilize SO₃ and/or trona injection prior to an ESP to effect a desirable change in the ORP of an ART of a WFGD.

TABLE 1

| | Grab | | | | | | | | | | |
|---|---|---|---|---|---|---|---|---|---|---|---|
| | Sample | | | | S₂O₈ by | | DCS | | | | |
| | ORP | | DO | Conductivity | Iodometry | | ORP | Dissolved | Total Hg | Selenite | Selenate |
| Date/Time | (mV) | pH | (mg/L) | (mS) | (mg/L) | pH | (mV) | Hg (μg/L) | (μg/L) | (μg/L) | (μg/L) |
| 11/15/12 | 243.70 | 5.40 | 0.00 | 0.00 | 0.00 | 0.00 | N/A | 3.83 | 473.80 | 76.98 | 73.01 |
| 14:35 | | | | | | | | | | | |
| 11/16/12 | 246.20 | 5.43 | 5.81 | 53.40 | 107.50 | 0.00 | N/A | 5.83 | 501.88 | 9.46 | 9.35 |
| 12:42 | | | | | | | | | | | |
| 11/17/12 | 235.70 | 5.56 | 5.05 | 33.80 | 115.20 | 0.00 | N/A | 7.96 | 558.55 | 159.83 | 73.41 |
| 10:45 | | | | | | | | | | | |
| 11/18/12 | 233.70 | 5.51 | 4.93 | 40.10 | 109.44 | 0.00 | N/A | 12.20 | 540.34 | 77.33 | 76.33 |
| 10:18 | | | | | | | | | | | |
| 11/19/12 | 245.60 | 5.56 | 5.20 | 38.90 | 109.44 | 0.00 | N/A | 10.60 | 533.04 | 22.56 | 83.99 |
| 10:20 | | | | | | | | | | | |
| 11/26/12 | 273.80 | 5.82 | 4.79 | 28.6 | 124.80 | 0.00 | N/A | 5.54 | 665.6 | 251.48 | 82.70 |
| 10:21 | | | | | | | | | | | |
| 11/27/12 | 266.90 | 5.78 | 5.62 | 32.80 | 115.20 | 5.75 | 249.00 | 9.73 | 585.70 | 265.09 | 933.27 |
| 9:59 | | | | | | | | | | | |
| 11/28/12 | 277.00 | 5.71 | 4.89 | 34.20 | 145.92 | 5.75 | 251.00 | 5.93 | 689.05 | 99.00 | 942.78 |
| 10:08 | | | | | | | | | | | |
| 11/29/12 | 279.40 | 5.64 | 4.42 | 33.60 | 126.72 | 5.72 | 250.00 | 7.27 | 613.27 | 246.27 | 1030.57 |
| 9:28 | | | | | | | | | | | |
| 11/30/12 | 298.90 | 5.61 | 4.21 | 33.00 | 167.00 | 5.72 | 247.00 | 8.40 | 594.52 | 69.27 | 995.66 |
| 8:50 | | | | | | | | | | | |
| 12/1/12 | 303.90 | 5.47 | 4.90 | 29.50 | 136.32 | 5.52 | 248.00 | 16.40 | 579.29 | 605.72 | 864.53 |
| 9:27 | | | | | | | | | | | |
| 12/2/12 | 301.90 | 5.11 | 4.46 | 34.30 | 117.12 | 5.15 | 248.00 | 23.50 | 559.98 | 431.29 | 882.29 |
| 9:35 | | | | | | | | | | | |
| 12/3/12 | 305.00 | 5.57 | 4.44 | 33.40 | 142.08 | 5.58 | 239.00 | 16.90 | 611.64 | 117.06 | 890.55 |
| 9:50 | | | | | | | | | | | |
| 12/4/12 | 289.50 | 5.43 | 4.71 | 40.70 | 140.16 | 5.66 | 238.00 | 17.90 | 631.47 | 58.91 | 802.47 |
| 9:10 | | | | | | | | | | | |
| 12/5/12 | 298.30 | 5.55 | 4.71 | 32.90 | 145.92 | 5.72 | 246.00 | 7.42 | 548.42 | 69.93 | 825.34 |
| 9:43 | | | | | | | | | | | |
| 12/6/12 | 391.10 | 5.48 | 6.04 | 36.30 | 190.08 | 5.58 | 244.00 | 1.57 | 604.95 | 31.68 | 854.26 |
| 9:02 | | | | | | | | | | | |
| 12/7/12 | 312.10 | 5.82 | 5.98 | 28.12 | 172.80 | 5.87 | 235.00 | 2.82 | 516.64 | 0.00 | 950.24 |
| 8:49 | | | | | | | | | | | |
| 12/10/12 | 283.00 | 5.98 | 5.72 | 30.30 | 192.00 | 5.73 | 199.00 | 0.97 | 518.21 | 68.06 | 984.01 |
| 11:34 | | | | | | | | | | | |
| 12/10/12 | 276.50 | 5.97 | 5.16 | 29.20 | 176.64 | 5.76 | 203.00 | 1.74 | 440.27 | 29.60 | 953.80 |
| 14:18 | | | | | | | | | | | |
| 12/11/12 | 265.60 | 5.82 | 5.50 | 27.91 | 161.28 | 5.71 | 204.00 | 3.24 | 411.71 | 0.00 | 718.18 |
| 9:46 | | | | | | | | | | | |
| 12/11/12 | 263.10 | 5.91 | 5.36 | 26.76 | 159.36 | 5.69 | 197.00 | 0.78 | 320.22 | 621.20 | 710.93 |
| 12:04 | | | | | | | | | | | |
| 12/11/12 | 272.40 | 5.84 | 5.36 | 23.98 | 140.16 | 5.62 | 214.00 | 1.54 | 376.82 | 607.40 | 693.59 |
| 16:02 | | | | | | | | | | | |
| 12/12/12 | 236.90 | 6.08 | 5.69 | 18.74 | 144.00 | 5.92 | 193.00 | 0.56 | 291.39 | 565.78 | 369.53 |
| 9:09 | | | | | | | | | | | |
| 12/12/12 | 238.50 | 6.01 | 5.47 | 20.07 | 174.72 | 5.82 | 194.00 | 0.47 | 319.13 | 588.50 | 343.22 |
| 12:24 | | | | | | | | | | | |
| 12/12/12 | 248.50 | 5.83 | 5.33 | 19.77 | 192.00 | 5.79 | 187.00 | 0.69 | 325.57 | 657.16 | 344.06 |
| 14:09 | | | | | | | | | | | |
| 12/13/12 | 249.60 | 5.98 | 5.85 | 20.78 | 174.72 | 5.69 | 197.00 | 1.29 | 0.83 | 686.95 | 345.52 |
| 9:24 | | | | | | | | | | | |
| 12/13/12 | 245.20 | 5.96 | 5.70 | 23.00 | 186.24 | 5.70 | 191.00 | 0.82 | 285.02 | 672.70 | 363.64 |
| 11:38 | | | | | | | | | | | |
| 12/13/12 | 250.00 | 5.79 | 5.03 | 25.26 | 174.12 | 5.67 | 196.00 | 1.62 | 394.50 | 571.96 | 371.59 |
| 13:39 | | | | | | | | | | | |
| 12/14/12 | 226.10 | 5.75 | 5.25 | 42.70 | 165.12 | 5.82 | 174.00 | 1.21 | 417.07 | 429.11 | 332.80 |
| 8:26 | | | | | | | | | | | |
| 12/14/12 | 236.50 | 5.94 | 5.49 | 45.00 | 182.40 | 5.73 | 178.00 | 1.64 | 419.78 | 364.70 | 307.97 |
| 11:32 | | | | | | | | | | | |
| 12/14/12 | 215.10 | 5.82 | 5.54 | 524.00 | 196.20 | 5.61 | 193.00 | 1.86 | 457.41 | 368.67 | 339.61 |
| 16:15 | | | | | | | | | | | |

TABLE 2

| | Grab | | | | | | | | | | |
|---|---|---|---|---|---|---|---|---|---|---|---|
| | Sample | | | | S₂O₈ by | | DCS | | | | |
| | ORP | | DO | Conductivity | Iodometry | | ORP | Dissolved | Total Hg | Selenite | Selenate |
| Date/Time | (mV) | pH | (mg/L) | (mS) | (mg/L) | pH | (mV) | Hg (μg/L) | (μg/L) | (μg/L) | (μg/L) |
| 11/15/12 | 295.00 | 4.95 | 4.90 | 0.00 | 0.00 | 0.00 | N/A | 4.60 | 372.00 | 673.95 | 49.81 |
| 14:31 | | | | | | | | | | | |
| 11/16/12 | 275.30 | 5.34 | 6.21 | 39.60 | 96.00 | 0.00 | N/A | 2.97 | 404.00 | 780.82 | 54.52 |
| 12:22 | | | | | | | | | | | |
| 11/16/12 | 255.50 | 5.12 | 5.60 | 52.50 | 130.60 | 0.00 | N/A | 4.61 | 406.00 | 793.68 | 62.78 |
| 15.42 | | | | | | | | | | | |
| 11/17/12 | 260.80 | 5.68 | 5.98 | 31.70 | 105.60 | 0.00 | N/A | 5.26 | 434.00 | 901.84 | 60.18 |
| 12:57 | | | | | | | | | | | |
| 11/17/12 | 257.20 | 5.40 | 9.35 | 31.30 | 96.00 | 0.00 | N/A | 0.00 | 418.00 | 511.40 | 88.57 |
| 15:15 | | | | | | | | | | | |
| 11/18/12 | 246.90 | 5.31 | 5.72 | 34.20 | 109.44 | 0.00 | N/A | 7.50 | 445.00 | 851.21 | 64.96 |
| 9:26 | | | | | | | | | | | |
| 11/18/12 | 254.10 | 5.20 | 5.70 | 33.60 | 97.92 | 0.00 | N/A | 7.53 | 462.00 | 800.51 | 63.48 |
| 12:46 | | | | | | | | | | | |
| 11/18/12 | 276.90 | 5.21 | 5.61 | 33.10 | 97.92 | 0.00 | N/A | 9.20 | 447.00 | 788.90 | 67.89 |
| 15:28 | | | | | | | | | | | |
| 11/19/12 | 249.80 | 5.49 | 5.75 | 33.00 | 94.08 | 0.00 | N/A | 6.16 | 456.00 | 789.18 | 64.15 |
| 9.44 | | | | | | | | | | | |
| 11/19/12 | 256.70 | 5.67 | 5.71 | 31.10 | 72.00 | 0.00 | N/A | 12.40 | 458.00 | 753.51 | 56.41 |
| 13:25 | | | | | | | | | | | |
| 11/19/12 | 252.90 | 5.59 | 5.99 | 30.90 | 129.60 | 0.00 | N/A | 1.48 | 420.00 | 766.59 | 53.76 |
| 15:18 | | | | | | | | | | | |
| 11/26/12 | 557.20 | 5.66 | 4.63 | 24.11 | 357.12 | 0.00 | N/A | 297.00 | 436.00 | 0.00 | 3259.90 |
| 11:08 | | | | | | | | | | | |
| 11/26/12 | 531-557 | 5.59 | 4.92 | 24.45 | 458.90 | 5.64 | 524.00 | 335.00 | 466.00 | 0.00 | 3199.28 |
| 13:23 | | | | | | | | | | | |
| 11/26/12 | 546.90 | 5.71 | 4.75 | 24.88 | 403.20 | 5.63 | 525.00 | 322.00 | 446.00 | 0.00 | 3456.03 |
| 15:26 | | | | | | | | | | | |
| 11/27/12 | 564.30 | 5.42 | 5.24 | 22.18 | 328.32 | 5.58 | 513.00 | 334.00 | 437.00 | 0.00 | 3339.24 |
| 9:03 | | | | | | | | | | | |
| 11/27/12 | 547.00 | 5.55 | 4.87 | 27.60 | 378.24 | 5.62 | 520.00 | 333.00 | 411.00 | 0.00 | 3322.38 |
| 12:42 | | | | | | | | | | | |
| 11/27/12 | 548.00 | 5.55 | 4.90 | 28.56 | 359.04 | 5.53 | 519.00 | 372.00 | 477.00 | 0.00 | 3511.92 |
| 16:14 | | | | | | | | | | | |
| 11/28/12 | 548.00 | 5.65 | 4.75 | 32.00 | 366.72 | 5.52 | 519.00 | 391.00 | 499.00 | 0.00 | 4547.54 |
| 9:27 | | | | | | | | | | | |
| 11/28/12 | 564.00 | 5.53 | 5.36 | 24.60 | 364.80 | 5.54 | 523.00 | 408.00 | 528.00 | 0.00 | 4076.00 |
| 13:35 | | | | | | | | | | | |
| 11/28/12 | 526.00 | 5.67 | 5.27 | 32.40 | 345.60 | 5.44 | 491.00 | 414.00 | 483.00 | 0.00 | 3776.43 |
| 15:35 | | | | | | | | | | | |
| 11/29/12 | 570.60 | 5.41 | 5.15 | 26.87 | 357.12 | 5.55 | 540.00 | 384.00 | 493.00 | 0.00 | 3849.11 |
| 10:09 | | | | | | | | | | | |
| 11/29/12 | 534.90 | 5.61 | 6.36 | 24.95 | 351.36 | 5.75 | 511.00 | 401.00 | 465.00 | 0.00 | 3950.23 |
| 13:00 | | | | | | | | | | | |
| 11/29/12 | 549.00 | 5.45 | 4.99 | 32.40 | 334.08 | 5.51 | 537.00 | 396.00 | 514.00 | 0.00 | 3896.06 |
| 15:30 | | | | | | | | | | | |
| 11/30/12 | 520.30 | 5.37 | 5.21 | 33.00 | 362.88 | 5.66 | 505.00 | 325.00 | 408.00 | 0.00 | 2613.99 |
| 9:21 | | | | | | | | | | | |
| 11/30/12 | 494.00 | 5.65 | 4.88 | 0.00 | 343.68 | 5.72 | 472.00 | 269.00 | 405.00 | 0.00 | 2258.24 |
| 14:06 | | | | | | | | | | | |
| 11/30/12 | 522.00 | 5.62 | 4.62 | 34.60 | 339.84 | 5.74 | 457.00 | 278.00 | 382.00 | 0.00 | 2153.89 |
| 15:47 | | | | | | | | | | | |
| 12/1/12 | 542.00 | 5.48 | 4.96 | 24.81 | 389.76 | 5.65 | 513.00 | 219.00 | 322.00 | 0.00 | 2448.43 |
| 8:51 | | | | | | | | | | | |
| 12/1/12 | 511.00 | 5.65 | 5.23 | 25.60 | 418.56 | 5.67 | 493.00 | 206.00 | 351.00 | 0.00 | 2456.52 |
| 11:50 | | | | | | | | | | | |
| 12/1/12 | 520.20 | 5.60 | 4.94 | 24.65 | 397.44 | 5.74 | 504.00 | 197.00 | 320.00 | 0.00 | 2352.68 |
| 14:22 | | | | | | | | | | | |
| 12/2/12 | 527.00 | 5.72 | 5.22 | 28.22 | 405.12 | 0.00 | 450.00 | 240.00 | 355.00 | 0.00 | 2613.65 |
| 9:05 | | | | | | | | | | | |
| 12/2/12 | 509.50 | 5.68 | 4.85 | 27.42 | 418.56 | 5.83 | 497.00 | 220.00 | 354.00 | 0.00 | 2516.77 |
| 14:30 | | | | | | | | | | | |
| 12/2/12 | 505.10 | 5.69 | 5.14 | 27.10 | 455.04 | 5.84 | 495.00 | 226.00 | 330.00 | 0.00 | 2465.82 |
| 16:00 | | | | | | | | | | | |
| 12/3/12 | 508.80 | 5.61 | 4.99 | 25.87 | 472.32 | 5.79 | 511.00 | 224.00 | 360.00 | 0.00 | 2389.62 |
| 10:22 | | | | | | | | | | | |
| 12/3/12 | 510.90 | 5.40 | 5.72 | 35.10 | 456.96 | 5.76 | 510.00 | 235.00 | 349.00 | 0.00 | 2362.08 |
| 13:40 | | | | | | | | | | | |
| 12/3/12 | 513.10 | 5.53 | 4.81 | 33.80 | 460.80 | 5.77 | 511.00 | 214.00 | 346.00 | 6.69 | 2330.85 |
| 15:40 | | | | | | | | | | | |
| 12/4/12 | 522.10 | 5.54 | 4.89 | 31.40 | 458.88 | 5.78 | 511.00 | 205.00 | 302.00 | 10.04 | 2210.91 |
| 9:47 | | | | | | | | | | | |
| 12/4/12 | 513.00 | 5.79 | 5.46 | 31.60 | 470.40 | 5.84 | 502.00 | 212.00 | 309.00 | 0.00 | 2260.63 |
| 13:45 | | | | | | | | | | | |
| 12/4/12 | 519.40 | 5.49 | 5.10 | 30.80 | 470.40 | 5.65 | 508.00 | 192.00 | 328.00 | 0.00 | 2215.08 |
| 15:22 | | | | | | | | | | | |
| 12/5/12 | 527.30 | 5.45 | 4.62 | 24.94 | 464.64 | 5.63 | 536.00 | 188.00 | 300.00 | 0.00 | 2336.88 |
| 10:00 | | | | | | | | | | | |
| 12/5/12 | 579.20 | 5.20 | 5.00 | 24.24 | 399.36 | 5.42 | 553.00 | 84.20 | 281.00 | 0.00 | 2371.02 |
| 13:50 | | | | | | | | | | | |
| 12/5/12 | 534.40 | 5.38 | 5.23 | 28.85 | 412.80 | 5.36 | 561.00 | 136.00 | 298.00 | 0.00 | 2466.75 |
| 16:55 | | | | | | | | | | | |
| 12/6/12 | 579.60 | 5.25 | 5.19 | 24.09 | 416.60 | 5.46 | 556.00 | 110.00 | 316.00 | 0.00 | 3345.74 |
| 9:24 | | | | | | | | | | | |
| 12/6/12 | 531.30 | 5.52 | 5.46 | 24.48 | 444.48 | 5.45 | 557.00 | 119.00 | 338.00 | 0.00 | 3568.89 |
| 11:41 | | | | | | | | | | | |
| 12/6/12 | 560.10 | 5.56 | 5.56 | 22.66 | 359.04 | 5.50 | 560.00 | 148.00 | 329.00 | 0.00 | 3394.87 |
| 16:45 | | | | | | | | | | | |
| 12/7/12 | 600.20 | 5.37 | 5.32 | 22.80 | 359.04 | 5.35 | 575.00 | 193.00 | 281.00 | 0.00 | 3571.63 |
| 9:16 | | | | | | | | | | | |
| 12/7/12 | 632.10 | 5.32 | 5.82 | 22.87 | 353.28 | 5.25 | 575.00 | 219.00 | 348.00 | 0.00 | 3711.37 |
| 11:23 | | | | | | | | | | | |
| 12/7/12 | 627.20 | 5.32 | 5.16 | 27.60 | 349.44 | 5.28 | 572.00 | 190.00 | 315.00 | 0.00 | 3853.27 |
| 12:45 | | | | | | | | | | | |
| 12/13/12 | 337.80 | 7.35 | 8.85 | 13.38 | 136.32 | 7.77 | 350.00 | 26.80 | 144.00 | 77.98 | 1698.63 |
| 9:46 | | | | | | | | | | | |
| 12/14/12 | 246.30 | 6.52 | 6.31 | 20.40 | 307.20 | 6.53 | 463.00 | 2.54 | 131.00 | 316.49 | 1942.57 |
| 8:40 | | | | | | | | | | | |

In one embodiment, the present invention permits control of various compounds and/or species in the ART of a WFGD which in turn can impact on the amount of total dissolved solids, selenite and/or selenite, mercury, and/or boron in an effluent stream of a WFGD.

In another embodiment, the present invention is directed to a method of controlling one or more upstream parameters so as to control the oxidation-reduction potential (ORP) in an absorber recirculation tank (ART). In one embodiment, it is desirable to control both the pH of the ART as well as the ORP therein. While not wishing to be bound to any one theory, in one embodiment the present invention is directed to controlling one or more upstream parameters so as to impact the pH and ORP in an ART. In one embodiment, it is desirable to achieve a pH of less than about 7, less than about 6.5, or less than about 6, or less than about 5.5, or even about 5 or less while at the same time controlling various factors that impact on the ORP (e.g., ESP sparking, the type and/or concentration of one or more oxidizers, etc.) so that the ORP is less than about 500 mV, less than about 450 mV, less than about 400 my, less than about 350 mV, or less than about 300 mV, or less than about 250 my, or less than about 200, or even about 150 mV (as measured by a silver/silver chloride electrode noting that these values may change if a Standard Hydrogen Electrode (SHE) is utilized). Here, as well as elsewhere in the specification and claims, individual numerical values can be combined to form additional and/or non-disclosed ranges. As would be appreciated by those of skill in the art, oxidation-reduction potential when measured at a pH of about 7 can generally range from a low of −0.8 V to a high of 1.2 V. It should also be noted that pH can influence the oxidation-reduction potential number, As such, the above range generally applies to the typical oxidation-reduction potential range when measured at pH 7. At other pHs different broad ranges could apply.

Accordingly, in another embodiment the present invention relates to one or more methods by which to control the ORP in an ART so as to reduce same. The reduction of the ORP in an ART can, in one embodiment, result in the formation of more desirable species and/or forms of one or more metals including, but not limited to, selenium, mercury, magnesium, cobalt, etc. As a non-limiting example, when the ORP in an ART is less than about 500 mV, less than about 450 mV, less than about 400 mV, less than about 350 mV, or even less than about 300 mV, the amount of selenium (IV) tends to be higher than when the ORP is above 500 mV. As an example, at an ORP of more than about 400 mV the amount of selenium (VI) tends to be much greater than the amount of selenium (IV) in an ART slurry and/or solution. Additionally, as the ORP in an ART slurry and/or solution further decreases below 400 my (e.g., below about 350 mV, or below about 325 mV, or even below 300 mV), the amount of selenium (VI) decreases and the amount of selenium (IV) increases. While not wishing to be bound to any one theory, it is believed that when the ORP in an ART slurry and/or solution is above 500 mV almost all, if not all, of the selenium present in the ART slurry and/or solution is in the form of selenium (VI) which in turn facilitates, or highly favors, the formation of various aqueous soluble selenium compounds and/or ions (e.g., selenate ions). This in turn results in selenium being undesirably discharged from one or more aqueous effluent streams and may, in the future, require additional emissions control technologies to reduce the amount of selenium emitted in various effluent streams. Thus, in various situations, it is desirable to control the ORP in an ART to thereby achieve at least some level of control over selenium speciation and in turn mitigate, reduce and/or control the concentration of various aqueous soluble selenium compounds and/or ions in various aqueous effluent streams. Given this, a reduction in the ORP in an ART below about 500 mV, below about 450 mV, below about 400 mV, below about 350 mV, or even below about 300 mV, results in at least some reduction, mitigation and/or control of the amount of aqueous soluble selenium compounds and/or ions that are emitted from one or more effluent streams from a WFGD. Furthermore, any additional reduction in the ORP in an ART below 300 mV can result in even more selenium being speciated as selenium (IV) and result in a further reduction, mitigation and control of aqueous soluble selenium compounds and/or ions in one effluent streams. Here, as well as elsewhere in the specification and claims, individual numerical values can be combined to form additional and/or non-disclosed ranges.

It should be noted that in some embodiments of the present invention it might be more desirable to mitigate, control and/or reduce the emission of one or more compounds and/or ions even if such mitigation, control and/or reduction causes an increase in the emission of one or more different compounds, ions and/or pollutants. In such cases, a second and different technology can be used to mitigate, reduce and/or control the emission of any such different compound, ion and/or pollutant which, although undesirable, is emitted at an increased level. As a non-limiting example, one might desire to have a higher degree of mitigation, reduction and/or control over selenium speciation. However, this may result in an undesirable increase in the emission of one or more other compounds, ions and/or pollutants (e.g., mercury reemission). Accordingly, rather than trying to achieve an ORP in the ART that impacts favorably on every compound, on and/or pollutant that one is seeking to mitigate, reduce and/or control, in some instances it could be, and typically is, desirable to utilize one or more other emissions control technologies to deal with any other compounds, ions and/or pollutants that may be emitted at an undesirable and/or increased amount (e.g., mercury reemission). In still another embodiment, it might be desirable to control, reduce and/or mitigate the type, amount and/or speciation of various other compounds, ions and/or pollutants via control of the ORP in an ART that will be unfavorable to selenium speciation while using a different emissions control technology to deal with any selenium that is emitted from one or more aqueous effluent streams or other emissions points. In summation, it might be necessary to “choose” a given ORP in an ART with the knowledge that by doing so one might selectively control a certain portion of total compounds, ions and/or pollutants that are sought to be controlled. Regarding the compounds, ions and/or pollutants that are not controlled via the selection of a favorable ORP in an ART for such a control process, these compounds, ions and/or pollutants could be controlled by one or more other emissions control technologies that do not solely depend on the ORP value in the ART.

In still another embodiment, when it is desired to control selenium speciation as well as mercury speciation, the present invention relates to a method that permits one to control the oxidation-reduction potential (ORP) in an ART so as to be in the range of about 300 mV to about 500 mV. While not wishing to be bound to any one theory, it is believed that at the typical pHs present in an ART when the ORP in such an ART is in a range of about 300 mV to about 500 m, mercury ions (e.g., in the form of mercury (II) and/or mercury (IV)) are the predominant species of mercury present in an WFGD instead of elemental mercury (Hg⁰). This in turn permits one to reduce the amount of mercury, reemission that occurs from a WFGD as mercury ions (e.g., in the form of mercury (II) and/or mercury (IV)) can be controlled via a number of technologies that result in mercury recapture in a WFGD.

In still another embodiment, the present invention seeks to control the ORP in an ART so as to mitigate, reduce and/or control the amount, type and/or concentration of one or more oxidizers in a WFGD and/or the ART of a WFGD. Another benefit of this embodiment of the present invention is that it results in a reduction in the generation of various gaseous species from the ART of a WFGD. For example, when the ORP in an ART is above about 500 mV various gaseous forms of the halogens can be generated. Such halogen gas generation is undesirable as it can lead to corrosive compounds escaping the ART of a WFGD and cause corrosion issues in one or more downstream emissions control devices,

Given the above, in one embodiment the present invention relates to a method for controlling at least one parameter that is directly, or indirectly, linked to a combustion process (e.g., a fossil fuel-based combustion process, biomass combustion process, etc.) in order to optimize at least one downstream emissions control device (e.g., a wet flue gas desulfurization unit, an SCR, a DSI, an ESP, a baghouse or fabric filter (FF), or other particulate collection device, etc,). In another embodiment, the present invention relates to a method for controlling at least one parameter that is directly, or indirectly, linked to a combustion process (e.g., a fossil fuel-based combustion process, biomass combustion process, etc.) in order to optimize at the oxidation-reduction potential in at least one downstream wet flue gas desulfurization unit.

In another embodiment the present invention relates to a method for controlling at least one parameter that is directly, or indirectly, linked to one or more emissions control device, or technology, in order to optimize at least one other upstream and/or downstream emissions control device (e.g., a wet flue gas desulfurization unit, an SCR, a DSI, an ESP, a baghouse or fabric filter (FF), or other particulate collection device, etc.). In another embodiment, the present invention relates to a method for controlling at least one parameter that is directly, or indirectly, linked to one or more emissions control device, or technology, in order to optimize at least the oxidation-reduction potential in at least one wet flue gas desulfurization unit.

In still yet another embodiment, the present invention relates to a method for controlling at least one parameter that is directly, or indirectly, linked to a combustion process (e.g., a fossil fuel-based combustion process, biomass combustion process, etc.) in combination with controlling at least one parameter that is directly, or indirectly, linked to one or more emissions control device, or technology in order to optimize at least one other upstream and/or downstream emissions control device (e.g., a wet flue gas desulfurization unit, an SCR, a DSI, an ESP, a baghouse or fabric filter (FF), or other particulate collection device, etc.). In still yet another embodiment, the present invention relates to a method for controlling at least one parameter that is directly, or indirectly, linked to a combustion process (e.g., a fossil fuel-based combustion process, biomass combustion process, etc.) in combination with controlling at least one parameter that is directly, or indirectly, linked to one or more emissions control device, or technology in order to optimize at least the oxidation-reduction potential in at least one wet flue gas desulfurization unit.

As noted above, in yet another aspect of the present invention, the present invention relates generally to the generation of steam via the use of a combustion process to produce heat and, in one embodiment, to a device, system and/or method that enables one to control one or more process parameters of a combustion process so as to yield at least one desirable change in at least one downstream parameter. In another embodiment, the present invention relates to a device, system and/or method for controlling and/or optimizing the performance of a DSI, ACI, WSI, WI and/or ESP by measuring, analyzing and/or controlling at least one or more operating parameters in real time. These parameters include, but are not limited to, boiler load, ESP power, ESP current, ESP voltage, opacity, particulate, ESP spark rate, SO₃ measurement, SO₂ measurement, O₂ measurement, ash resistivity measurement, VOC measurement, air heater outlet temperature, air heater speed, SCR inlet temperature, SCR outlet temperatures, SCR catalyst SO₂ to SO₃ conversion rates, flue gas weights, flue gas flow, injection rates for DSI, injection rate for WSI, injection rates for ACI, and Hg emissions.

This invention is a method of optimizing DSI, ACI, WSI, WI and/or ESP performance by measuring, analyzing and/or controlling at least one or more operating parameters in real time. These parameters are boiler load, ESP power, ESP current, ESP voltage, opacity, particulate, ESP spark rate, SO₃ measurement, SO₂ measurement, measurement, ash resistivity measurement, VOC measurement, air heater outlet temperature, air heater speed. SCR inlet temperature, SCR outlet temperatures, SCR catalyst SO₂ to SO₃ conversion rates, flue gas weights, flue gas flow, injection rates for DSI, injection rate for WSI, injection rates for ACI, and Hg emissions. Additional parameters that may be considered for control are discussed in Steam/its generation and use, 41^{st} Edition, Kitto and Stultz, Eds., Copyright 2005, The Babcock & Wilcox Company, Barberton, Ohio, U.S.A., the complete text of which is hereby incorporated by reference as though fully set forth herein. Accordingly, the present invention is not to be construed as limited to just the parameters discussed above. Rather, it can be applied broadly to measure, analyze and/or control a wide range of boiler, or furnace, device parameters and related air quality control system device parameters and utilize these parameters for controlling and/or optimizing the performance of one or more of a DSI, ACI, WSI, WI and/or ESP.

DSI and/or WSI systems are typically installed on utility and industrial boilers/combustors for the purpose of eliminating the blue plume from SO₃/H₂SO₄ emissions at the stack, minimizing PAC poisoning from SO₃, reducing other acid gases such as SO₂, HF, HBr and HCl, reducing VOC's, reducing total particulate, and lowering the acid dew point to reduce air heater corrosion and/or corrosion on other downstream equipment. The presence of SO₃ in the gas stream can help improve the performance of the ESP. It helps to reduce the resistivity of the ash which helps ESP performance. When the DSI and/or WSI system removes too much SO₃, the performance of the ESP can decrease resulting in higher opacity and particulate emissions. However, while SO₃ helps ESP performance, SO₃ concentrations as low as 5 ppm in the gas stream may result in increased PAC consumption. Higher concentrations of SO₃ negatively impacts PACs ability to remove Hg which results in increased PAC consumption. This control scheme analyzes the various performance parameters listed above and adjusts the sorbent flow rate of the DSI and/or WSI system such that the optimum amount of SO₃ is removed while minimizing the impact on ESP performance and PAC injection rate. The ESP, DSI, WSI and ACI systems all have an impact on each other. This current control scheme helps to take advantage of the synergies that exist between these systems with the goal of minimizing sorbent consumption from the DSI and/or WSI system and PAC consumption from the ACI system (if present).

In one embodiment, the present invention is able to predict and/or monitor DSI and/or WSI injection rates by calculating SO₃ concentration and using this information and/or data to control and/or optimize one of more of the DSI and/or WSI injection rates. In one instance the data generated by calculating the SO₃ concentration can be utilized to generate a control algorithm, and such control algorithm can be utilized to control and/or optimize DSI and/or WSI injection rates in real-time. In one instance, the calculation of the SO₃ concentration is dependent upon one or more factors including, but not limited to, the O₂ in the system, air heater outlet temperature, fuel type, the SO₂ concentration and oxidation of SO₂ to SO₃ across an SCR catalyst.

Alternatively, the SO₃ concentration could be measured and that feedback would be used in the calculation. In this embodiment, the injection rate could then be calculated from the SO₃ concentration prediction, the required SO₃ removal efficiency and the stoichiometric ratio of sorbent to SO₃. The injection rate will be biased based on feedback from the various ESP parameters including ESP outlet opacity, spark rate and power as well as PAC injection rates and Hg emissions. Alternatively, ESP power could be the main control parameter and the DSI and/or WSI rates could be biased to keep the ESP at desired power levels. By controlling the DSI and/or WSI or ACI rate and biasing the other, savings of sorbent may be realized. Boilers typically do not operate at steady state. Changes in load will vary the gas flow rate, gas temperature and the boiler O₂ concentration. These will have significant impacts on the amount of SO₃ formed. In one instance, where feedback of SO₃ concentration with an instrument is not practical, control and/or optimization of the one or more injection rates can be accomplished by predictive algorithms for SO₃ concentration. By controlling and/or optimizing one or more of the injection rates via a prediction of SO₃ concentration, the instances of over and/or under injection of sorbent will be minimized, thus minimizing those times, or time intervals, when the ESP is riot functioning within a given parameter range. Such times may result in ESP upsets and result in high particulate excursions which in turn can lead to WFGD scrubber upsets or even out of compliance instances for particulate matter (PM) emissions.

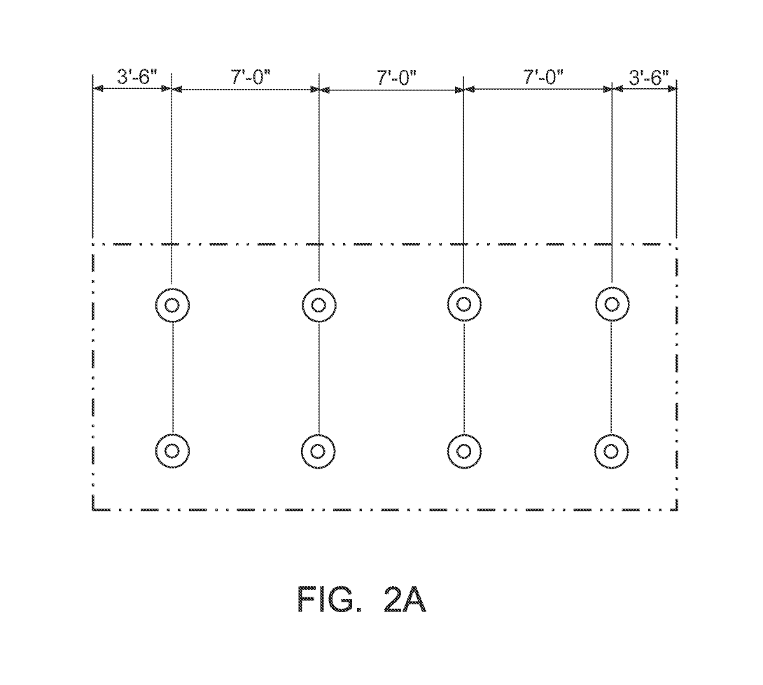

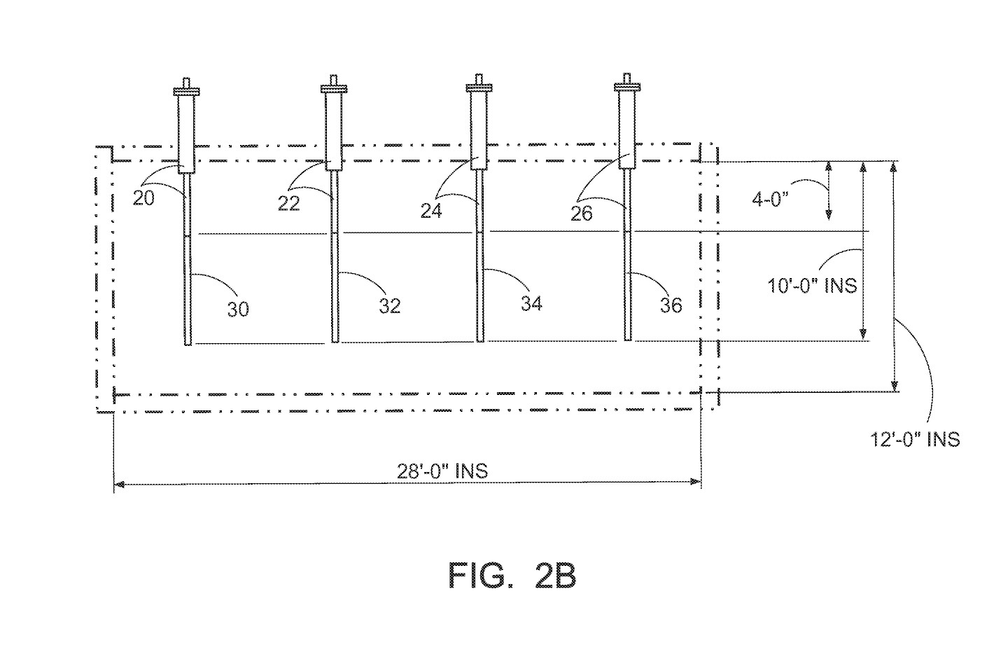

In another embodiment, the present invention can also be used to control SO₃ distribution within the flue work by biasing the DSI and/or WSI injection rates to the areas of the flue where SO₃ concentrations may differ. This is accomplished by controlling the individual injection lance flow rates or by controlling which injection lances are in or out of service during any instance in time in order to bias the sorbent injection rates/distribution within the flue work. SO₃ is known to stratify in the flue gas downstream of a regenerative air heater, the area where the rotor comes from the air side will have low SO₃ concentration and the areas where the rotor goes to the air side will have high SO₃ concentration. Since the air heating baskets coming from the air side are at a cooler temperature, SO₃ condensation is high in these areas and the gaseous SO₃ concentration is low. The opposite is true when the rotor reaches the air side again. If there is a uniform injection of sorbent in the system, the removal efficiencies of SO₃ will vary in the flue, depending on the mixing in the flue of DSI and the residence time from the point of DSI and or WSI to the ESP. While the actual SO₃ concentration at the ESP is difficult to measure, a surrogate for SO₃ will be ESP power/sparking and/or ESP volts/amps. If the ESP power in a particular field is too low, it may indicate SO₃ deficiencies in that area. As an alternative to reducing the total amount of DSI and/or WSI to the system, this invention will control the flow to the individual lances or shut off a single or multiple lances to redistribute DSI and/or WSI in the system to correct the ESP power or sparking issue. For example, FIGS. 2A and 2B shows a typical DSI distribution grid having a first set of sorbent injection lances 20, 22, 24 and 26 and a second set of sorbent injection lances 30, 32, 34 and 36. Although lances 20, 22, 24 and 26 are shown to be shorter than lances 30, 32, 34 and 36, other embodiments where both sets of lances are of equal lengths, or where three or more different sets of lances of equal or different lengths are also contemplated. In the DSI distribution grid of FIGS. 2A and 2B, if the ESP power is low in the fields near the south flue, DSI and/or WSI injection can be shut off at lance 36 or at lances 26 and 36 to redistribute the flow of DSI and/or WSI in the system and bring the power levels back up to optimal levels.

Common sorbents for DSI and/or WSI include, but are riot limited to, trona, hydrated lime, sodium bicarbonate, liquid sodium based systems, magnesium hydroxide, calcium carbonate and other sodium, calcium, potassium, magnesium, or alkali based sorbents, iron-bearing compounds, kaolin or kaolin-bearing compounds, one or more halogen-bearing compounds, or combinations of any two or more thereof. Typical injection locations can be implemented anywhere from the coal feeder to the inlet of the ESP. In addition, common sorbents for Hg control are not necessarily limited to PAC, halogenated PAC and amended silica.

While not wishing to be bound to any particular one or more advantage, the present invention has a number of advantages over current methods for control of one or more of the DSI, WSI, WI, ACI and/or ESP systems: (i) the present invention can be used to optimize DSI and/or WSI sorbent injection rates, PAC injection rates and/or ESP performance; (ii) the present invention permits the synergistic control and/or optimization of the performance of one or more of the DSI, WSI, WI, ACI and/or ESP systems. Individually, these systems can impact the performance of the other system(s) in a positive or negative way. This control technology helps the systems to work in unison; (iii) the present invention can achieve cost savings by reduced sorbent usage and subsequent reduction in cost associated with ash disposal; (iv) the present invention protects the WFGD from excursions of particulate loading which will impact both gypsum purity and the concentration of heavy metals discharged to the WFGD wastewater treatment system; (v) the present invention provides emission control during changes in operating conditions and improves system reliability; (vi) the present inventions permits the control and/or optimization of the performance of one or more of the DSI, WSI, WI, ACI and/or ESP systems during changes in load; (vii) the present invention provides automated system control; and (viii) the present invention permits, by the measurement of ESP power input, ESP volts, and/or ESP amps at each ESP electrical bus section, one to predict the SO₃ stratification within a given ESP and thereby facilitate the adjustment of the sorbent flow rate to one or more different zones within a gas stream.

In another instance, the present invention elates to controlling and/or optimizing the injection rate of one or more of DSI, WSI, WI, ACI and/or ESP systems via feedback from the a plant's OEMS (continuous emission monitoring systems), ESP power, ESP current density, ESP primary voltage and current, ESP secondary voltage and current.

In light of the above, the present invention relates in one embodiment to a device, system and/or method that permits, as disclosed and described herein, one to control and/or optimize the performance of one or more of a DSI, ACI, WSI, WI and/or ESP by measuring, analyzing and/or controlling one or more operating parameters in real time.

In yet another aspect of the present invention, the present invention relates to a device, system and/or method that permits, as disclosed and described herein, one to control and/or optimize the performance of one or more of a DSI, ACI, WSI, WI and/or ESP by measuring, analyzing and/or controlling one or more operating parameters in real time, where the operating parameters are selected from boiler load, ESP power, ESP current, ESP voltage, opacity, particulate, ESP spark rate. SO₃ measurement, SO₂ measurement, O₂ measurement, ash resistivity measurement, VOC measurement, air heater outlet temperature, air heater speed, SCR inlet temperature, SCR outlet temperatures. SCR catalyst SO₂ to SO₃ conversion rates, flue gas weights, flue gas flow, injection rates for DSI, injection rate for WSI, injection rates for ACI, and Hg emissions, or combinations of any two or more thereof.

In still yet another aspect of the present invention, the present invention relates to a method for optimizing a combustion system (e.g., a fossil fuel-fired combustion system or any other type of combustion system regardless of the type of fuel combusted), AQCS train, one or more additive injection systems and/or types, and/or WFGD absorber chemistry and performance through the use of the control of one or more inputs and/or parameters, or system inputs and/or parameters, using one or more control systems including, but not limited to, one or more of distributed control systems (DCSs) and/or programmable logic control systems (PLCs).

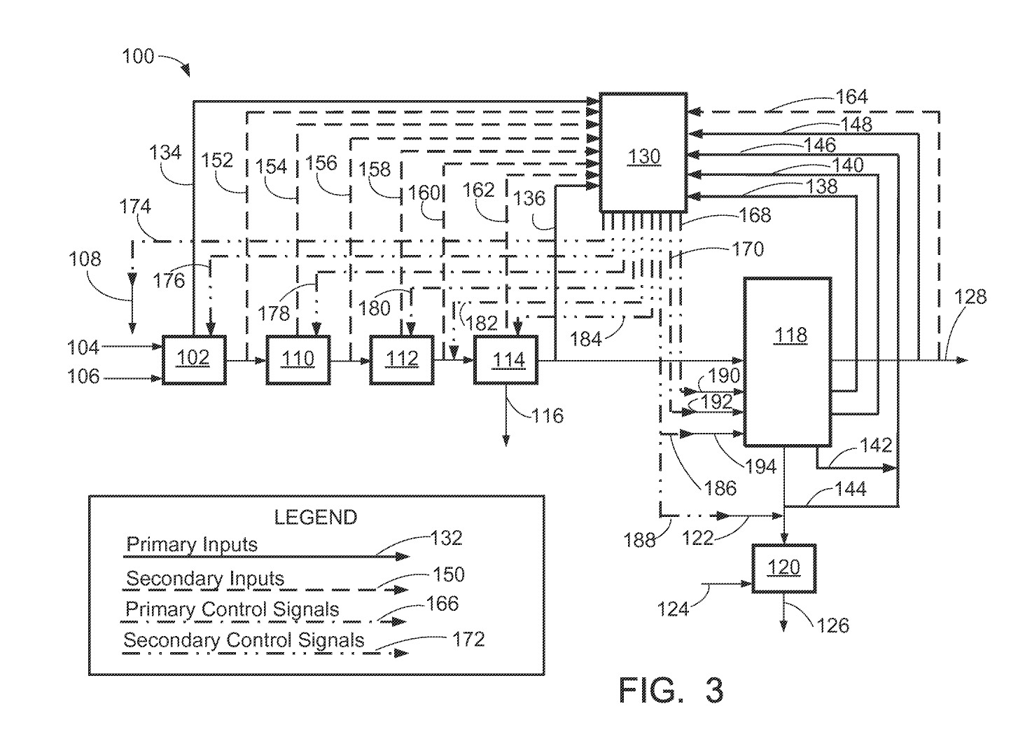

Turning to FIG. 3, FIG. 3 represents a non-limiting example of a fossil fuel-fired boiler system and related AQCS devices. It should be noted that the present invention is not limited to the layout of FIG. 3. Rather, as would be known to those of skill in the art, one or more of the various AQCS devices of boiler system 100 of FIG. 3 could be eliminated and/or replaced by other types of similar AQCS devices that achieve the same end result but in a different manner and/or technique. In one embodiment, FIG. 3 represents a diagram of a fossil fuel-fired boiler system having one or more possible primary and/or secondary inputs that are used to provide information and/or feedback to one or more optimizer and/or controllers of the present invention thereby enabling the method of the present invention to output one or more primary and/or secondary control signals to achieve optimization of the fossil fuel-fired boiler system and/or one or more AQCS devices associated therewith.

Specifically, system 100 of FIG. 3 comprises a boiler (or furnace) 102 that is fueled by one or more fuels 104 including, but not limited to, one or more fossil fuels (e.g., coal, any type of oil, natural gas, etc.), any coal/biomass combination, or any coal/bone meal combination or even pure biomass in combination with air 106; an SCR 110; at least one dry sorbent injection (DSI) system 112; at least one particulate collection device (e.g., an electrostatic precipitator (ESP)) 114; and at least one wet flue gas desulfurization (WFGD) unit 118. It should be noted that the air denoted by arrow 106 is not to be strictly construed as atmospheric air. As known to those of skill in the art the “air” that can be used to fuel the combustion that takes place in boiler (or furnace) 102 can be over-fired air, recycled flue gas, or any other type of air that those of skill in the ad know can be provided to a combustion process to produce, among other things, heat. Additionally, as would be known to those of skill in the art the combustion process that takes place in boiler (or furnace) 102 also produces a flue gas or combustion gas stream that is then treated to remove one or more compounds, particulates, or other items therefrom in one or more of the AQCS devices 110, 112, 114 and 118 (or even additional non-pictured AQCS devices) before being discharged as is denoted by arrow 128 to the atmosphere or to the outside of system 100.

Although not specifically identified with their own reference numerals each of these devices are connected to one another as shown in FIG. 3 by conduits, flues and/or ducts known to those of skill in the art. These conduits, flues and/or ducts are represented by the horizontal arrows between components 102, 110, 112, 114 and 118 of FIG. 3. It should be noted that various AQCS devices discussed herein might not be needed for all types of boilers and/or furnaces that combust one or more of the above-identified combustible fuels. For example, some systems in accordance with the present invention might not need SCR, or other type of NOₓ control device, might not need a DSI system, or some other type of AQCS device. Furthermore, in one embodiment the present invention is directed to optimized combustion systems that utilize one or more WFGD units and as such the presence or absence of the remainder of the AQCS devices discussed herein should be construed in a non-limiting manner.

In another embodiment, system 100 can further include one or more air heaters, one or more heat exchangers, or any other devices that are known to those of skill in the art for use in connection with combustion systems and/or fossil fuel-fired combustion systems. Regarding SCR 110, SCR 110 could be either a hot side SCR or a cold side SCR. It still another embodiment, SCR 110 can be replaced by a SNCR. Although system 100 of FIG. 3 illustrates an embodiment that utilizes DSI system 112, DSI system 112 can be replaced by any suitable type of system or device that permits mercury capture and/or oxidation through the use of one or more additives or compounds. Such systems and/or compounds that are known to those of skill in the art to capture and/or achieve mercury oxidation include, but are not limited to, halide-bearing compounds (e.g., one or more fluorine-, chlorine-, bromine- and/or iodine-containing inorganic and/or organic compounds), one or more phyllosilicates, one or more inorganic sulfides, one or more organic sulfur-containing compounds, etc.

Turning to the at least one particulate collection device 114, in another embodiment device 114 can be selected from one or more of a fabric filter (FF) or baghouse, one or more electrostatic precipitators (ESPs), or one or more wet electrostatic precipitators (wet ESPs). Alternatively, any other suitable particulate control device can be utilized in conjunction with system 100. In still another embodiment, particulate collection device 114 outputs ash 116.

Regarding WFGD unit 118, as is known to those of skill in the art WGFD unit 118 can, in some instances, be utilized to produce gypsum for use in such products as drywall, etc. Additionally, as is illustrated in FIG. 3, WFGD unit 118 further includes one or more reagent inputs 190, 192 and 194. In one embodiment inputs 190, 192 and 194 are an air (such as oxidation air or some other suitable type of air for the WFGD unit 118) input line 190, a limestone input line 192, and a one or more additive input lines 194 (although only one is shown multiple additive input lines 194 could be present). In another embodiment WFGD 118 could utilize different inputs rather than air and limestone. For example, another alkaline sorbent or reagent can be utilized in place of limestone, one such a non-limiting example is lime (CaO) or slaked lime (Ca(OH)₂). Alternatively, another type of “air” could be utilized in the WFGD rather than atmospheric air. Such atmospheric air substitutes are known to those of skill in the art and as such a detailed list herein is omitted for the sake of brevity.

In one embodiment, additive input line 194 (or multiple additive input lines 194) can be used to provide one or more additives such as one or more reducing agents to control, as one non-limiting example, the ORP in the WFGD; one or more sulfur-containing compounds such as one or more inorganic sulfides, one or more organic sulfur-containing compounds, or mixtures of any two or more thereof to control, as one non-limiting example, mercury re-emission; one or more aluminum-silicate compounds or materials such as kaolin or kaolinite; one or more phyllosilicates; one or more waste water treatment chemicals to control at least one of the solubility of one or more compounds, the solubility of one or more ions (e.g., metal ions), the speciation (i.e., the valence state or oxidation state) of one or more ions, etc.; one or more transition metal-containing compounds or chemicals (e.g., one or more iron-bearing compounds); or mixtures of two or more of any such chemicals. Depending on the one or more additives that are provided to WFGD unit 118 such one or more additives can be provided to either one, or both, of the absorption zone, the flue prior to entry into the WFGD 118, the slurry or solution contained in the absorption circulation tank or zone of the WFGD, or any combination of two or more thereof.

In still another embodiment, one or more, or any combination, of the various additives disclosed in U.S. Pat. Nos. 8,303,919; 8,691,719; and/or 8,716,169 can be injected at the one or more various injection points disclosed therein. Given this the complete texts of U.S. Pat. Nos. 8,303,919; 8,691,719; and/or 8,716,169 are incorporated herein in their entireties for all that they disclose and/or teach. Such injection points include, but are not limited to, mixed with, or placed on, the coal or other fuel (via, for example, additive supply line 108); in the furnace and/or in the economizer thereof; upstream of the SCR or SNCR, if present; upstream of the WFGD; within the WFGD as described above; and/or any combination thereof. In another embodiment, in addition to any of the above additives, or instead of, one or more of the compounds disclosed in United States Patent Application Publication No. 2014/0017119 can be utilized. As such, the complete text of United States Patent Application Publication No. 2014/0017119 is incorporated herein in its entirety for all that it discloses and/or teaches.

Furthermore, in some instances it is also desirable to control the formation of various acidic ions, metal ions and/or compounds, or any combination thereof that form during the combustion process. Suitable ions, atoms, compounds, metals and/or metal-containing compounds include, but are not limited to, one or more ions, atoms, compounds, metals and/or metal-containing compounds that contain one or more of Ag, Al, As, B, Ba, Be, Ca, Cd, Co, Cu, Cr, Fe, K, Mg, Mn, Mo, Na, Ni, Pb, Sb, Se, Si, Sr, Ti, TI, U, V, W and/or Zn. As would be apparent to those of skill in the art upon reading and understanding the present invention as disclosed herein, not all of the above metal and/or elements need to be controlled in all situations. In fact, in some instances, some of the metals or other elements, or compounds that contain such metals or other elements, are provided to the one or more combustion processes disclosed herein. In still another embodiment, it is also desirable to control the formation of various acidic ions in the presence of persulfate ions as they will react in the presence of calcium cations to form calcium sulfate and the corresponding halogen gas. This halogen gas will then further react in the slurry, or solution, of the ART to form, respectively, hypochlorite ions, hypobromite ions, and/or hypoiodite ions as illustrated by the exemplary equations below.

S₂O₈²⁻+2Cl⁻+2Ca²⁺→2CaSO₄²⁻+Cl₂

S₂O₈²⁻+2Br⁻+2Ca²⁺→2CaSO₄²⁻+Br₂

S₂O₈²⁻+2I⁻+2Ca²⁺→2CaSO₄²⁻+I₂

Cl₂+H₂O→2H⁺+Cl⁻+ClO⁻

Br₂+H₂O→2H⁺+Br⁻+BrO⁻

I₂+H₂O→2H⁺+I⁻+IO⁻

While not wishing to be bound to any one theory, the formation of hypochlorite ions, hypobromite ions, and/or hypoiodite ions is believed to negatively impact the pH and the ORP in the slurry, or solution, of an ART.

Returning to system 100 of FIG. 3, WFGD 118 is shown to provide effluent or overflow solution from the WFGD to at least one waste water treatment (WWT) unit 120. As shown therein, any one or more of the above additives can be provided to the waste water from WFGD unit 118 prior to entry into the waste water treatment unit 120 via supply line 122 and/or to waste water treatment unit 120 via supply line 124 so as to control one or more compounds, ions, and/or elements, or to meet one or more effluent limitation guidelines as set by any regulatory body (e.g., the US EPA) and discharge, where applicable, at least one effluent via line 126. As would be apparent to those of skill in the art, in some embodiments discussed herein the amount of effluent emitted via line 126 can be substantially reduced or eliminated.

In another embodiment, various regulatory agencies such as the EPA are setting new effluent limitation guidelines (ELG) for utilities. As such, waste water treatment unit 120 can be replaced if so desired by one or more bioreactors. Various bioreactors for use in waste water treatment are known in the art and as such this embodiment of the present invention is not limited to any one type of bioreactor for waste water treatment. As is known to those of skill in the art, bioreactors harness enzymatic reaction for control and/or removal of constituents of concern, such as selenate, from the influent stream to the bioreactor. When influent streams have a high ORP and/or high oxidizer content, bioreactor functionality is compromised and utilities may go out of compliance with regard to their wastewater discharge permits. By controlling the ORP and oxidizer content of the streams going to the bioreactor, bioreactor functionality is maintained.

In another embodiment, waste water treatment unit 120 can be replaced by one or more liquid reduction and/or zero liquid discharge systems as known to those of skill in the art Examples of such systems include, but are not limited to, those disclosed in U.S. Patent Application No. 62/002,584 filed May 23, 2014, the complete text of which is incorporated herein by reference in its entirety for all that it discloses and/or teaches.

Returning to FIG. 3, in one embodiment the present invention relates to a system 100 as described above that contains at least one optimizer unit 130. As disclosed herein, optimizer 130 permits the input or one or more primary inputs generated from the process conditions and/or parameters from one or more of the AQCS devices of system 100. As is illustrated in FIG. 3, primary inputs 132 are denoted by solid lines and include, but are not limited to, data relating to the load, the fuel supply rate, and/or the fuel conditions of boiler (or furnace) 102 which are supplied to optimizer 130 via connection 134. Additional primary inputs to optimizer 130 include one or more of: (i) inlet SO₂ concentration or level prior to entry of the flue gas into WFGD unit 118 as supplied to the optimizer 130 via sensor and/or feedback connection 136; (ii) WFGD tower level as supplied to the optimizer 130 via sensor and/or feedback connection 138; (iii) WFGD unit 118 pH level as supplied to the optimizer 130 via sensor and/or feedback connection 140; (iv) the ORP of the absorber recirculation tank (ART) of the WFGD unit 118 via sensor and/or feedback connection 142 that connects to optimizer 130 via connection 146; (v) the ORP of the absorber recirculation tank (ART) effluent or waste water output of the WFGD unit 118 via sensor and/or feedback connection 144 that connects to optimizer 130 via connection 146; and/or (vi) outlet SO₂ concentration or level contained in the treated flue gas exiting from WFGD unit 118 as supplied to the optimizer 130 via sensor and/or feedback connection 148.

Thus, in one embodiment, the one or more primary inputs to optimizer 130 are utilized to generate one or more outputs so as to permit the control and/or optimization of one or more of the components 102, 110, 112, 114, 118 and/or 120 of system 100. In another embodiment, the one or more primary inputs to optimizer 130 can be combined with one or more secondary inputs to optimizer 130 to generate one or more outputs so as to permit the control and/or optimization of one or more of the components 102, 110, 112, 114, 118 and/or 120 of system 100. In still another embodiment, one or more of the secondary inputs to optimizer 130 can be utilized alone to generate one or more outputs so as to permit the control and/or optimization of one or more of the components 102, 110, 112, 114, 118 and/or 120 of system 100. Given this, the secondary inputs 150 to optimizer 130, the primary outputs 166 from optimizer 130, and the secondary outputs 172 from optimizer 130 will now be discussed in detail. It should be noted that any combination of one or more optimizer inputs in conjunction with any combination of one or more optimizer outputs disclosed herein can be utilized regardless of whether such combination is specifically detailed herein.

Turning to the secondary inputs 150 to optimizer 130 such secondary inputs 150 include one or more of: (a) the flue gas O₂ content, concentration and/or level as measured upon exit of the flue gas from boiler (or furnace) 102 as supplied to the optimizer 130 via sensor and/or feedback connection 152; (b) the ammonia (NH₃) injection rate of SCR unit 110, or the injection rate of urea of an SNCR unit if used in place of SCR unit 110, as supplied to the optimizer 130 via sensor and/or feedback connection 154; (c) the outlet NO, level and/or concentration in the flue exiting either the NO control device (e.g., an SCR or SCNR) 110 as supplied to the optimizer 130 via sensor and/or feedback connection 156; (d) the injection rate, if applicable, of one or more sorbents in one or more DSI injection units 112 (if present) as supplied to the optimizer 130 via sensor and/or feedback connection 158; (e) the sulfur concentration and/or the type of sulfur compound present (e.g., the amount of SO₂ versus SO₃ present) as the flue gas exits DSI unit 112 (if present) as supplied to the optimizer 130 via sensor and/or feedback connection 160; (1) the spark rate and/or power level of ESP unit 114, the primary and/or secondary ESP voltage, the primary and/or secondary ESP current, and/or the ESP gas flux, or if the particulate control device is some other type of particulate control then one or more operating parameters associated therewlth, as supplied to the optimizer 130 via sensor and/or feedback connection 162; and/or (g) the mercury level, concentration and or type (be it oxidized mercury or elemental mercury) in the flue gas exiting the WFGD unit 118 as supplied to the optimizer 130 via sensor and/or feedback connection 164.

In light of the above, one or more of the primary inputs 132 alone, one or more of the secondary inputs 150 alone, and/or any combination of primary inputs 132 and secondary inputs 150 that are supplied to optimizer 130 where optimizer 130 processes such data using a distributed control system (DCS) and/or programmable logic control (PLC) to output one or more primary control signals 166, one or more secondary control signals 172, or any combination of one or more primary control signals 166 with any one or more secondary control signals 172 can be utilized to optimize and/or control the various process parameters of one or more of the components that make up system 100. In another embodiment, optimizer 130 can utilize any type of logic, neural network or other computer-based programming to process the data or other information provided by one or more of the primary inputs 132 and/or secondary inputs 150 to generate one or more primary control signals 166 and/or one or more secondary control signals 172 so as to optimize and/or control the various process parameters of one or more of the components that make up system 100.

Turning to the one or more output control signals generated by optimizer 130 of the present invention, as noted above optimizer 130 generates one or more primary control signals 166 and/or one or more secondary control signals 172 including one or more of: (i) the air supply rate to WFGD unit 118 via control signal output 168 from optimizer 130; (ii) the limestone, lime and/or slaked lime supply rate to WFGD unit 118 via control signal output 170 from optimizer 130; (iii) fuel additive injection rate and/or concentration as supplied via supply line 108 to the fuel of system 100 via control signal output 174 from optimizer 130; (iv) combustion control bias of system 100 via control signal output 176 from optimizer 130; (v) SCR parameter, or parameters, control and/or NH₃ injection rate bias, or alternatively SNCR parameter, or parameters, control and/or urea injection rate bias, via control signal output 178 from optimizer 130; (vi) DSI injection rate, type and/or concentration, if present, via control signal output 180 from optimizer 130; (vii) PAC injection rate, type, etc., if applicable and/or present, via control signal output 182 from optimizer 130; (viii) particulate control bias and/or control of other particulate unit process parameters (e.g., ESP control bias, ESP spark rate, ESP spark level, ESP voltage, ESP current, ESP power, etc.) via control signal output 184 from optimizer 130; (ix) WFGD additive injection rate, concentration and/or type as supplied via supply line 194 to the ART of WFGD unit 118 via control signal output 186 from optimizer 130; and/or (x) additive injection rate, concentration and/or type as supplied via supply line 122 to effluent from the ART of WFGD unit 118 prior to entry into any suitable waste water treatment unit 120 via control signal output 188 from optimizer 130.

In another embodiment, in addition to those inputs and outputs listed above one or more of the following system inputs to a combustion system as listed below of can be monitored to provide data to one or more optimizers so as to generate one or more control signal outputs to control any one or more components of any known combustion system described herein. In this embodiment, such one or more optimizer inputs include, but are not limited to, various inputs generated from ad/or by measuring and/or monitoring: WFGD ART oxidation-reduction potential (ORP); gypsum suspended solids (TSS); WFGD ART pH level; ESP operating parameters; NO, output from the NO, control device (e.g., SCR or SNCR); fuel input (coal analysis and fuel flow (lbs/hr) and/or Megawatts, and/or BTU/hr output from the furnace); limestone and/or lime analysis from the material supplied to the WFGD; reagent flow into the WFGD tower; inlet SO₂ concentration at the inlet to the WFGD; oxidation air flow to the WFGD tower; electrical resistance probes (one or more of which can be utilized where it is desirable to determine the likelihood of corrosion and/or metal loss for example in a WFGD ART), one or more probes or corrosion sensors in any of the ductwork or flues of system 100 as to determine one or more parameters and/or rneasureable properties (e.g., gas temperature to check for dew point corrosion) and/or conductivity probes to monitor to presence and/or concentration of one or more conductive species (e.g., conductive aqueous species); WFGD inlet opacity; dissolved oxygen level and/or concentration in the WFGD slurry and/or ART; operating WFGD, or other flue gas desulfurization unit (FGD) operating Pi data; DSI flow rate; PAC flow rate; load; gas flux; gas chemistry; flue gas temperature; any one or more of the additive addition rates; and/or reagent feed to any one or more of the WWT units 120.

In one embodiment, such one or more optimizer outputs include, but are not limited to, operational tower level in the WFGD unit 118; reagent feed flow to one or more of the WFGD unit 118 and/or any of the other units and/or components of system 100 where at least one reagent and/or additive is utilized; oxidation air flow rate to the WFGD unit 118; rate of absorber bleed; liquid-to-gas ratios including, but not limited to, liquid-to-gas ratios for the WFGD unit 118; number of operating absorber recirculation pumps in the WFGD unit 118; dewatering (e.g., hydroclone) operation parameters; ammonia or urea feed rate; number of particulate control feeds and/or fields (e.g., baghouse and/or fabric filter feeds, and/or ESP fields) in operation; gypsum purity; gypsum related scale formation in the absorber tower of the WFGD unit 118; parasitic power loss by the WFGD equipment; WFGD effluent stream to waste water treatment parameters; SO₂ removal efficiency; DSI flow rate and/or type (if applicable); one or more additive addition rates at any additive supply point; and/or PAC flow rate (if applicable).

Thus, in one embodiment, this invention present invention entails an optimizer to control WFGD chemistry and ORP through process optimization. In another embodiment, the present invention entails injection of a reducing agent into the WFGD, through a site such as at the absorber recirculation pump, controlled by a local or DOS controller with feedback based on ORP to control the stream chemistry being fed to a bioreactor. In still another embodiment, the present invention entails an optimizer controlling the WFGD chemistry through process optimization and through controlled addition of a reducing agent. While not wishing to be bound to any one advantage, the one or more various embodiments of the present invention offer improved performance of bioreactors for wastewater treatment, specifically but not limited to, treatment of WFGD blow down. By maintaining the chemistry of the influent stream to the bioreactor, performance predictions can be met. Without this treatment, changes in chemistry associated with changed in load, coal, AQCS unit operation and/or other parameters may cause a loss of compliance for effluent discharge quality.

Although not limited hereto one suitable DOS controller that can be utilized as optimizer 130 can be designed from a server type computer system having the necessary hardware and software components therein. One non-limiting example is a server system having two Dual Core Xeon Processors (e.g., 2 GHz or higher), a suitable amount of memory (e.g., 4 GB RAM or more), a suitable amount of storage space in the form of one or more hard drives, flash memory devices, etc. (e.g., four 80 GB or larger hard drives, non-RAID configuration, hardware controlled), one or more network adapters and/or interface cards (e.g., two Ethernet cards), one or more optical drives (e.g., one OD-RW/DVD ROM Drive), a monitor, a mouse (or other input device such as a touchscreen monitor) and keyboard. In some instances, a modem might be desired. As far as the minimum software requirements, they include, but are not limited to, an operating system such as Microsoft Windows Server 2012 R2 Standard Edition, Microsoft SQL Server 2012, and Microsoft Office (or some other office suite). In some instances it might be desirable to install a program such as Symantec pcAnywhere 12.5 or later, or an equivalent thereof from another publisher. Alternatively, optimizer 130 can be any semiconductor-based device that is able to function as a DOS controller where one or more inputs are utilized to create and/or send one or more control signals and/or outputs.

Furthermore, in another embodiment, the present invention permits for a more responsive and/or detailed control system which will allow the WFGD system to function better during times of non-steady state operation by the furnace and/or boiler. More coal-fired utilities are undertaking, for example, swinging boiler load to allow for steady power grid operation. A more responsive control system may lead to a better tower chemistry which can aid in improving SO₂ removal efficiency; better distribution of DSI will improve ACI utilization and mercury control as well as improve ESP performance.

Additionally, the ORP levels that have been observed in some WFGD towers have been shown to lead to destruction of bio-reactors and phase partitioning of the slurry constituents such as manganese and selenium. The phase partitioning can lead to high levels of metals, such as selenium, in the effluent stream to the waste water stream. Controlling ORP to a pre-determined range and steady state condition may help mitigate corrosion potential in the tower as well as to control elemental vapor phase mercury formation and re-emission. Also, an optimization program that will help to control the SCR (or SNCR) and/or ESP (or other particulate control device) parameters may lead to less ammonia or urea injection, less DSI and ACI sorbent usage and better performance of the ESP or other particulate control device. Another non-limiting advantage of the present invention is that the process disclosed herein has the potential to mitigate parasitic power loss of the equipment.

In another embodiment, the present invention addresses the issue that there are currently not any other effective variables that could economically and accurately be used to control sorbent/PAC flow other than ESP power input. It is possible to control the DSI and/or WSI sorbent feed rates based on SO₃ measurement. However, at this time SO₃ analyzer long term reliability has not been demonstrated. The SO₃ concentration in the gas stream is stratified and as a result, multiple analyzers and/or probes are required. Also, the probe(s) would need to be located in a high ash environment, thus requiring a substantial amount of maintenance.

As discussed herein and as known to those of skill in the art, WFGD units are designed to operate for a coal, or range of coals, used as a design basis and to run at steady-state, full load. As utilities operate the boilers at swinging or low-load conditions in order to respond to dispatch demands of the grid, the gas flux into the scrubber also changes. These changes in gas flux and SO₂ loading, along with changes in concentration of other flue gas constituents caused by the other unit operations responding to changes in loading conditions, can result in very different chemistries within the absorber and may change the gaseous (mercury) and effluent composition (mercury, selenium, other metals, pH, ORP, oxidizer concentration). These changes in chemistry may also affect the scaling potential of the WFGD absorber and thereby impact ancillary equipment operation and maintenance as well.

Thus, in one embodiment, the present invention relates to a process and/or method to control and/or stabilize the WFGD scrubber chemistry and/or operation in response to swinging and low-load operation. Signals from the scrubber unit and combustion process operations are provided to an optimizer (e.g., a DCS-based optimizer) and are analyzed as disclosed herein. As discussed above, using such one or more inputs the optimizer of the present invention sends one or more control signals back to one or more of the components of a combustion system (e.g., system 100 described above) to respond to changes or variations in any one or more of the input signals to the optimizer of the systems and/or methods of the present invention. Thus, in various embodiments, the present invention offers one or more advantages of improved effluent chemistries in terms of composition, such as improved pH, ORP, oxidizer content, mercury and/or selenium and/or other metals speciation. In the absence of mercury control additives, the present invention may reduce mercury emissions from the scrubber in some cases by reducing the duration of transient chemistries.

In another embodiment, the various methods and/or processes of the present invention address various acid gas issues. As is known to those of skill in the art, acid gases (e.g., HQ, HBr, H₂SO₄, etc.) may condense in the ductwork of one or more AQCS devices in the AQCS train (e.g., near or before the WFGD inlet). This condensation occurs because the gas temperature drops below the dew point temperature for the given pressure of one or more of these gases, causing liquid acid to contact the surfaces of the flue work and/or WFGD inlet. As these areas are often constructed of lower alloys or carbon steel, severe corrosion often results. The systems, method and/or processes disclosed herein can various embodiments permit for the control and/or adjustment of one or more boiler parameters such as soot blowing or economizer flow rates to try to control and/or reduce the flue gas temperatures in the furnace areas and/or flue gas temperature exiting the various portions of the boiler systems.

Thus, in one embodiment, the present invention utilizes automated logic, such as through an optimizer or other centralized control network, to lessen or to prevent this acid gas condensation. Temperature monitoring is performed at various points of the AQCS train of many power plants. This data can be used as inputs into a control device, Curves can be generated, based upon equilibrium thermodynamics, to predict the dew point (condensation temperature) for each acid in question from the flue gas at various pressures and gas compositions. These curves can be used, combined with input data about the temperature throughout the gas path, to create control output set points regarding a minimum temperature to remain above to prevent acid gas condensation and thus prevent corrosion. Signals would be output to intelligent soot blowing and/or tunable parameters in boiler to adjust heat absorption, thus controlling flue gas temperature. The addition of the particular economizer and associated control system designs and methods such as those disclosed in U.S. Pat. Nos. 7,578,265 and 7,637,233, incorporated herein by reference in their entireties for all that they disclose and/or teach, may also allow for a control parameter for the flue gas exit gas temperature.

While specific embodiments of the present invention have been shown and described in detail to illustrate the application and principles of the invention, it will be understood that it is not intended that the present invention be limited thereto and that the invention may be embodied otherwise without departing from such principles. In some embodiments of the invention, certain features of the invention may sometimes be used to advantage without a corresponding use of the other features. Accordingly, all such changes and embodiments properly fall within the scope of the following claims.

1-23. (canceled)

24. A method for optimizing one or more components of a combustion system, the method comprising the steps of:
(I) measuring, collecting and/or analyzing data from at least one parameter selected from:
(a) a load, a fuel supply rate, and/or one or more fuel conditions of a boiler;
(b) inlet SO₂ concentration or level prior to entry of the flue gas into a WFGD unit;
(c) WFGD tower level;
(d) WFGD unit pH level;
(e) absorber recirculation tank ORP;
(f) WFGD effluent ORP from an ART of the WFGD;
(g) outlet SO₂ concentration or level contained in a treated fine gas exiting from a WFGD unit;
(h) flue gas O₂ content, concentration and/or level as measured upon exit of the flue gas from a boiler or furnace;
(i) reagent injection rate for a NOₓ control device;
(j) outlet NOₓ level and/or concentration in the flue exiting either the NOₓ control device;
(k) injection rate of one or more sorbents in one or more DSI injection units;
(l) sulfur concentration and/or the type of sulfur compound present as the flue gas exits a DSI unit;
(m) spark rate and/or power level of an ESP unit, primary and/or secondary ESP voltage, primary and/or secondary ESP current, and/or ESP gas flux, or if particulate control device is achieved by some other type of particulate control device than one or more operating parameters associated therewith; and/or
(n) mercury level, concentration and or type in the flue gas exiting a WFGD unit;
(II) generating data from the at least one parameter of Step (I); and
(III) using the data generated in Step (II) to adjust at least one operational parameters of one or more components of a combustion system selected from a boiler or furnace, one or more NOₓ control devices, one or more DSI units, one or more particulate control units, one or more WFGD units, one or more waste water treatment devices, or any combination of two or more thereof.

25. The method of claim 24, wherein the one or more parameters that are adjusted in Step (III) include one or more of
(i) an oxidation air supply rate to the one or more WFGD units;
(ii) limestone, lime and/or slaked lime supply rate to the one or more WFGD units;
(iii) any one or more fuel additive injection rates and/or concentrations;
(iv) combustion control bias of the boiler or furnace:
(v) one or more NO control device parameters, control and/or NH₃ injection rate bias, control and/or urea injection rate bias;
(vi) DSI injection rate, type and/or concentration and/or SO₃ concentration;
(vii) PAC injection rate and/or type;
(viii) particulate control unit bias and/or control of other particulate unit process parameters;
(ix) WFGD additive injection rate, concentration and/or type;
(x) additive injection rate, concentration and/or type as supplied to any injection point in the combustion system; and/or
(xi) any waste water treatment unit and/or system parameter.

26. The method of claim 24, wherein the method includes a step of adding at least one of SO₃, trona, or other sodium sorbent, whether wet or dry, to an electrostatic precipitator and controlling the amount of such one or more compounds to the electrostatic precipitator so as to reduce the amount of sparking that occurs in an electrostatic precipitator while injecting one or more of SO₃, trona, or other sodium sorbent, whether wet or dry, versus the amount of sparking that occurs without such injection.

27. The method of claim 24, wherein the method includes a step of controlling the amount of sparking that occurs in an electrostatic precipitator so as to reduce the concentration and/or type of one or more oxidizers that are formed as a result of the sparking.

28. The method of claim 24, wherein the method includes a step of controlling the amount of sparking that occurs in an electrostatic precipitator so as to reduce the concentration and/or type of one or more oxidizers that are formed in the electrostatic precipitator.

29. The method of claim 28, wherein the one or more oxidizers that are controlled are selected from persulfate, permanganate, manganate, ozone, hypochlorite, chlorate, nitric acid, iodine, bromine, chlorine, fluorine, or combinations of any two or more thereof.

30. The method of claim 24, wherein the method permits control of both the oxidation-reduction potential and the pH in the solution of an absorber recirculation tank.

31. The method of claim 30, wherein the oxidation-reduction potential in the solution of an absorber recirculation tank is less than about 500 mV and the pH is less than about 7.

32. The method of claim 30, wherein the oxidation-reduction potential in the solution of an absorber recirculation tank is less than about 450 mV and the pH is less than about 6.5.

33. The method of claim 30, wherein the oxidation-reduction potential in the solution of an absorber recirculation tank is less than about 400 mV and the pH is less than about 6.

34. The method of claim 30, wherein the oxidation-reduction potential in the solution of an absorber recirculation tank is less than about 350 mV and the pH is less than about 6.

35. The method of claim 30, wherein the oxidation-reduction potential in the solution of an absorber recirculation tank is less than about 300 mV and the pH is less than about 6.

36. The method of claim 24, wherein the method permits control of the oxidation-reduction potential in the solution of an absorber recirculation tank so that the oxidation-reduction potential is less than about 500 mV.

37. The method of claim 24, wherein the method permits control of the oxidation-reduction potential in the solution of an absorber recirculation tank so that the oxidation-reduction potential is less than about 450 mV.

38. The method of claim 24, wherein the method permits control of the oxidation-reduction potential in the solution of an absorber recirculation tank so that the oxidation-reduction potential is less than about 400 mV.

39. The method of claim 24, wherein the method permits control of the oxidation-reduction potential in the solution of an absorber recirculation tank so that the oxidation-reduction potential is less than about 350 mV.

40. The method of claim 24, wherein the method permits control of the oxidation-reduction potential in the solution of an absorber recirculation tank so that the oxidation-reduction potential is less than about 300 mV.

41. The method of claim 24, wherein the method permits control of at least the selenium speciation in the absorber recirculation tank solution while simultaneously permitting control of mercury reemission from the wet flue gas desulfurization unit.

42. The method of claim 24, wherein the method permits control of at least the selenium speciation in the absorber recirculation tank solution.

43. The method of claim 24, wherein the method permits control of one or more of the selenium speciation, the manganese speciation, the cobalt speciation, the mercury speciation, or any two or more thereof in the absorber recirculation tank solution.

44. The method of claim 24, wherein the method permits the real time monitoring of any one or more of the parameters of Step (I).

45. The method of claim 24, wherein the method permits the real time control of any one or more of the parameters of Step (III).

46. The method of claim 25, wherein the method permits the real time control of any one or more of the parameters of claim 25.

47. (canceled)
